(19) United States
(12) Patent Application Publication
(10) Pub. No.: US 2026/0315721 A1
(43) Pub. Date: Oct. 15, 2026

(54) MODULAR OXYGEN CONCENTRATOR

(71) Applicant: QINGDAO AUGREENER ELECTRONIC TECHNOLOGY CO., LTD., Shandong (CN)

(72) Inventors: Mingshan WANG, Shandong (CN); Benrong ZHANG, Shandong (CN); Qiang RUAN, Shandong (CN); Tongshuai LIU, Shandong (CN); Zeguo SUN, Shandong (CN)

(21) Appl. No.: 19/465,281

(22) Filed: Jan. 30, 2026

Related U.S. Application Data
(63) Continuation-in-part of application No. PCT/CN2025/087759, filed on Apr. 8, 2025.

(30) Foreign Application Priority Data
Dec. 18, 2024 (CN) 202411874749.9

(51) Int. Cl. A61M 16/10; A61M 16/20; B01D 53/047; C01B 13/02

(52) U.S. Cl. CPC A61M 16/101; A61M 16/20; B01D 53/0476; C01B 13/0262; A61M 2205/07; A61M 2205/121; A61M 2205/125; A61M 2205/8206; B01D 2253/116; B01D 2256/12; B01D 2257/102

(57) ABSTRACT

A modular oxygen concentrator including: a main frame module including a main frame, and an oxygen storage tank and a control assembly disposed inside the main frame; a compressor module located on one side of the main frame and slidably and detachably connected to the main frame by a first detachment structure; a molecular sieve module located on another side of the main frame and slidably and detachably connected to the main frame by a second detachment structure; and a battery module located on a lower side of the main frame and slidably and detachably connected to the main frame by a third detachment structure. The compressor module, the molecular sieve module, and the battery module can be independently attached and quickly detached.

### CROSS REFERENCE TO REPLATED APPLICATIONS

The present application is a continuation in part of PCT/CN2025/087759, filed Apr. 8, 2025, which claims priority to Chinese Patent Application No. 202411874749.9, filed Dec. 18, 2024, the entire contents of which are incorporated herein by reference in their entireties.

### BACKGROUND

This disclosure relates to a technical field of oxygen generation equipment, and in particular to a modular oxygen concentrator.

At present, a household oxygen concentrator mainly relies on an air compressor to compress air, and separates and extracts oxygen from the air by a molecular sieve to provide pure oxygen for home use. In a common product form of the household oxygen concentrator, a molecular sieve tank and an air compressor are both integrated inside equipment as core components. However, this integrated design has some shortcomings, especially a service life of a molecular sieve is critical to performance of an oxygen concentrator, and once aging or a failure occurs, a user always needs to replace the entire equipment, which not only increases use costs, but also limits equipment maintainability and equipment sustainability.

In Patent Publication No. CN210656150U, an oxygen concentrator having a detachable module detachable from an oxygen concentrator main body is disclosed. In this design, a compressor and a molecular sieve tank are integrated in the detachable module, so that when the molecular sieve tank or the compressor needs to be replaced or maintained, the detachable module can be detached from the oxygen concentrator main body to implement separate replacement or maintenance. This design, to some extent, solves problems of difficult maintenance and high use costs of the oxygen concentrator. However, in the above solution, since the molecular sieve tank and the compressor share one detachable module, when the molecular sieve tank or the compressor needs to be replaced separately, the entire module still needs to be detached, resulting in cumbersome detachment and attachment operations, which is inconvenient for a user to perform finer maintenance.

### SUMMARY

Based on the technical problems in the related art, this disclosure provides a modular oxygen concentrator that enables efficient integration and independent detachment of various functional modules, thereby improving equipment maintainability and reducing use costs.

This disclosure provides a modular oxygen concentrator including:
a main frame module including a main frame, and an oxygen storage tank and a control assembly disposed inside the main frame;
a compressor module located on one side of the main frame and slidably and detachably connected to the main frame by a first detachment structure;
a molecular sieve module located on another side of the main frame and slidably and detachably connected to the main frame by a second detachment structure; and
a battery module located on a lower side of the main frame and slidably and detachably connected to the main frame by a third detachment structure.

In some embodiments, the first detachment structure and the second detachment structure are both located at a bottom of the main frame, and after the battery module is detached, the first detachment structure and the second detachment structure can be released from a locked state.

Compared with the related art, this disclosure has the following advantages and positive effects.

According to the modular design of the above modular oxygen concentrator, the compressor module, the molecular sieve module, and the battery module can be independently attached and quickly detached, which not only improves independence of respective functional modules, but also greatly simplifies maintenance and replacement operations of the oxygen concentrator. In an actual use, when a module fails or needs to be replaced periodically, a user can replace the corresponding module separately according to the needs without complex detaching or repair of the entire equipment, which not only reduces maintenance costs and a downtime, but also improves a long-term use stability of the oxygen concentrator.

### BRIEF DESCRIPTION OF THE SEVERAL VIEWS OF THE DRAWINGS

In order to more clearly describe technical solutions of embodiments of this disclosure, accompanying drawings that need to be used in description of some embodiments will be briefly introduced below, it is obvious that the accompanying drawings in the following description are merely some embodiments of this disclosure, and those skilled in the art can obtain other drawings according to these drawings without creative efforts.

FIG. 1 is a perspective view of a modular oxygen concentrator in one or more embodiments of this disclosure;

FIG. 2 is a perspective view of the modular oxygen concentrator in one or more embodiments of this disclosure when viewed from another viewing angle;

FIG. 3 is a state diagram of a battery module detached from the modular oxygen concentrator in one or more embodiments of this disclosure;

FIG. 4 is a schematic diagram of detaching and attaching functional modules from and to the modular oxygen concentrator in one or more embodiments of this disclosure;

FIG. 5 is a perspective view in a bottom view direction of the oxygen concentrator after the battery module is detached from the modular oxygen concentrator in one or more embodiments of this disclosure;

FIG. 6 is a perspective view of a main frame module in the modular oxygen concentrator in one or more embodiments of this disclosure;

FIG. 7 is a perspective view of the main frame module in the modular oxygen concentrator in one or more embodiments of this disclosure when viewed from another viewing angle;

FIG. 8 is a second perspective view of a compressor module in the modular oxygen concentrator in one or more embodiments of this disclosure when viewed from another viewing angle;

FIG. 9 is a perspective view of the compressor module in the modular oxygen concentrator in one or more embodiments of this disclosure;

FIG. 10 is a perspective view of the compressor module in the modular oxygen concentrator in one or more embodiments of this disclosure when viewed from another viewing angle, and is a top view;

FIG. 11 is a perspective view of the compressor module in the modular oxygen concentrator in one or more embodiments of this disclosure when viewed from another viewing angle, and is a bottom view;

FIG. 12 is a longitudinal cross-sectional view of the modular oxygen concentrator in some embodiments of this disclosure;

FIG. 13 is an enlarged view of a part II in FIG. 12;

FIG. 14 is a perspective view of a molecular sieve module in a modular oxygen concentrator in some other embodiments of this disclosure;

FIG. 15 is a longitudinal cross-sectional view of the modular oxygen concentrator of FIG. 14;

FIG. 16 is an enlarged view of a part III in FIG. 15;

FIG. 17 is a longitudinal cross-sectional view of a modular oxygen concentrator in some other embodiments of this disclosure;

FIG. 18 is a schematic structural diagram of a molecular sieve fastener in FIG. 17;

FIG. 19 is a schematic structural diagram of the battery module in the modular oxygen concentrator in one or more embodiments of this disclosure;

FIG. 20 is a cross-sectional view of the modular oxygen concentrator in one or more embodiments of this disclosure;

FIG. 21 is an enlarged view of a part I in FIG. 20;

FIG. 22 is an exploded view of a quick detachment assembly in the battery module;

FIG. 23 is a cross-sectional view of the main frame module in the modular oxygen concentrator in one or more embodiments of this disclosure, and shows an auxiliary oxygen storage tank;

FIG. 24 is a perspective view of the main frame module in one or more embodiments of this disclosure;

FIG. 25 is a perspective view of the compressor module in one or more embodiments of this disclosure;

FIG. 26 is a schematic structural diagram of the compressor module with a compressor outer shell removed;

FIG. 27 is a schematic structural diagram of the compressor module with the compressor outer shell removed when viewed from another viewing angle;

FIG. 28 is schematic structural diagram of the compressor module with the compressor outer shell removed when viewed from another viewing angle;

FIG. 29 is a perspective view of a muffling cover in one or more embodiments of this disclosure;

FIG. 30 is a perspective view of a compressor bottom shell in one or more embodiments of this disclosure;

FIG. 31 is a perspective view of the compressor bottom shell in one or more embodiments of this disclosure when viewed from another viewing angle;

FIG. 32 is a bottom view of the compressor bottom shell in one or more embodiments of this disclosure;

FIG. 33 is a top view of the compressor bottom shell in one or more embodiments of this disclosure;

FIG. 34 is a perspective view of the molecular sieve module with a molecular sieve outer shell removed in one or more embodiments of this disclosure;

FIG. 35 is a perspective view of the molecular sieve module with the molecular sieve outer shell removed in one or more embodiments of this disclosure

FIG. 36 is a schematic diagram of a connection structure of an air distribution valve and a molecular sieve cylinder in one or more embodiments of this disclosure;

FIG. 37 is a schematic structural diagram of a valve seat in one or more embodiments of this disclosure;

(a) and (b) in FIG. 38 are schematic structural diagrams of seat interfaces in one or more embodiments of this disclosure when viewed from different viewing angles;

FIG. 39 is a cross-sectional view of an air distribution valve in one or more embodiments of this disclosure;

FIG. 40 is a cross-sectional view of a nitrogen discharge pipe/air inlet pipe and the seat interfaces in one or more embodiments of this disclosure;

FIG. 41 is a cross-sectional view of a connection structure between the molecular sieve module and the main frame module in one or more embodiments of this disclosure;

FIG. 42 is a schematic diagram of an attachment structure of the main frame module and a molecular sieve air receiving seat in one or more embodiments of this disclosure; and

FIG. 43 is a perspective view of the molecular sieve air receiving seat in one or more embodiments of this disclosure.

Reference Numerals: 10 main frame module; 11 main frame; 111 base portion; 1111 limiting slot; 1112 first slot limiting member; 1113 second slot limiting member; 1114 engagement port; 1115 molecular sieve key attachment hole; 1116 molecular sieve button attachment hole; 1117 limiting through hole; 1118 main frame opening; 1119 accommodation groove; 112 vertical frame portion; 1121 third slot limiting member; 113 upper frame portion; 1131 air inlet; 1132 air outlet hole; 1133 air outlet; 12 control assembly; 13 fan; 14 oxygen storage tank; 141 auxiliary oxygen storage tank; 15 locking member; 16 molecular sieve key; 17 molecular sieve button; 18 molecular sieve fastener; 181 fastening column; 182 handle; 191 compressor air receiving seat; 192 molecular sieve air receiving seat; 1920 air receiving seat attachment groove; 1921 main body portion; 1922 attachment plate; 1923 oxygen outlet channel; 1924 second threaded hole; 1925 nitrogen discharge channel; 1926 air inlet channel; 1101 first electrical connector; 1102 third electrical connector; 1103 fifth electrical connector; 1104 cover body; 11041 cover body extension portion; 20 compressor module; 21 compressor shell assembly; 211 limiting edge; 212 air inlet cavity; 213 compressor air outlet interface; 214 air inlet region; 215 filtering cavity opening; 216 external heat dissipation port; 217 internal heat dissipation port; 22 compressor; 23 compressor key; 24 second electrical connector; 231 compressor outer shell; 232 compressor inner shell; 221 compressor bottom shell; 2211 air discharge grille; 2213 air discharge attachment groove; 2214 snap accommodation groove; 2215 engagement protrusion; 222 compressor cover; 2221 second air inlet hole; 233 compressor joint; 2331 air outlet channel; 2332 nitrogen inlet channel; 30 molecular sieve module; 3021 molecular sieve outer shell; 3022 molecular sieve cylinder; 3023 molecular sieve inner shell; 3031 slot; 31 third sliding portion; 32 locking groove; 33 engagement pawl; 34 molecular sieve air inlet interface; 35 molecular sieve oxygen outlet interface; 36 fourth electrical connector; 37 fastening hole; 38 auxiliary air inlet; 40 battery module; 41 battery module outer shell; 411 sliding portion; 412 through hole; 413 battery key attachment hole; 42 battery assembly; 43 quick detachment assembly; 431 battery key; 4311 key main body; 4312 force applying portion; 432 snap; 433 elastic member; 434 attachment seat; 44 sixth electrical connector; 5 air inlet muffling portion; 51 muffling cover; 511 cover body; 512 extension portion; 513 snap; 5131 groove; 52 first muffling cavity; 521 air inlet cavity; 5211 first air inlet hole; 522 filtering cavity; 5221 support member; 53 communication hole; 54 partition plate; 55 sealing cover; 56 second muffling cavity; 561 air outlet hole; 6 air discharge muffling portion; 61 air discharge muffling portion nitrogen inlet; 62 air discharge muffling portion nitrogen discharge port; 7 air distribution valve; 71 valve seat; 711 pressure equalizing valve attachment hole; 712 solenoid valve attachment hole; 713 first oxygen delivery pipeline; 714 nitrogen discharge pipeline; 715 air inlet pipeline; 716 connection hole; 72 seat interface; 721 second oxygen delivery pipeline; 722 first hole; 723 second hole; 724 third threaded hole; 81 oxygen outlet pipe; 82 nitrogen discharge pipe; 83 air inlet pipe; 841 pipe body; 842 protrusion; 87 sealing ring; 88 solenoid valve; 89 fastener.

### DETAILED DESCRIPTION OF THE DISCLOSURE

Technical solutions in embodiments of this disclosure will be clearly and completely described below with reference to the accompanying drawings in some embodiments of this disclosure, and obviously, the described embodiments are merely a part of embodiments of this disclosure, and are not all embodiments. Based on some embodiments of this disclosure, all other embodiments obtained by those skilled in the art without creative efforts shall fall within the scope of this disclosure.

In the description of this disclosure, it should be understood that orientations or positional relationships indicated by terms “center”, “upper”, “lower”, “front”, “rear”, “left”, “right”, “vertical”, “horizontal”, “top”, “bottom”, “inner”, “outer”, and the like are based on orientations or positional relationships shown in the drawings, and are merely for the convenience of describing this disclosure and simplifying the description, rather than indicating or implying that the indicated device or element must have a specific orientation or must be constructed and operated in a specific orientation, and thus, these cannot be understood as a limitation of this disclosure.

In the description of this disclosure, it should be noted that, unless otherwise explicitly specified and limited, terms “attachment”, “coupling”, and “connection” should be understood in a broad sense, for example, these terms may represent a fixed connection, a detachable connection, or an integral connection. For those skilled in the art, specific meanings of the above terms in this disclosure may be understood according to specific situations. In the descriptions of the one or more embodiments, specific features, structures, materials, or characteristics may be combined in an appropriate manner in any one or more embodiments or examples.

Terms “first” and “second” are used for description only, and cannot be understood as indicating or implying relative importance or implicitly representing the number of indicated technical features. Therefore, features limited to “first” and “second” may explicitly or implicitly include one or more of the features. In the description of this disclosure, unless otherwise specified, “a plurality of” means two or more.

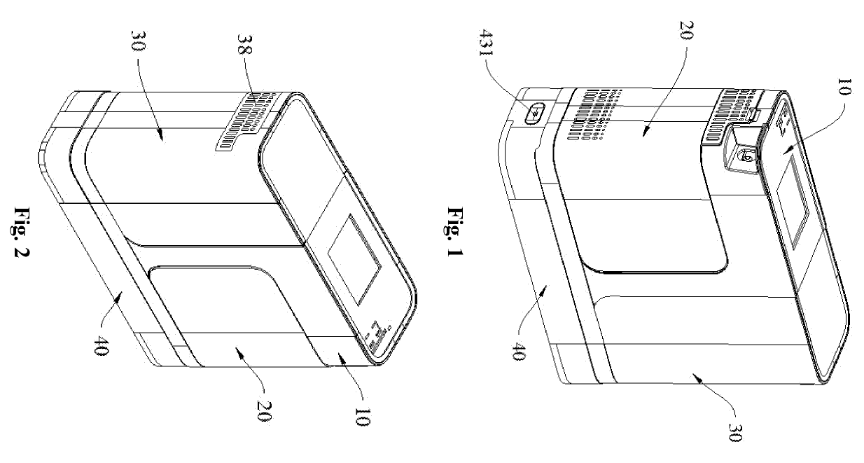

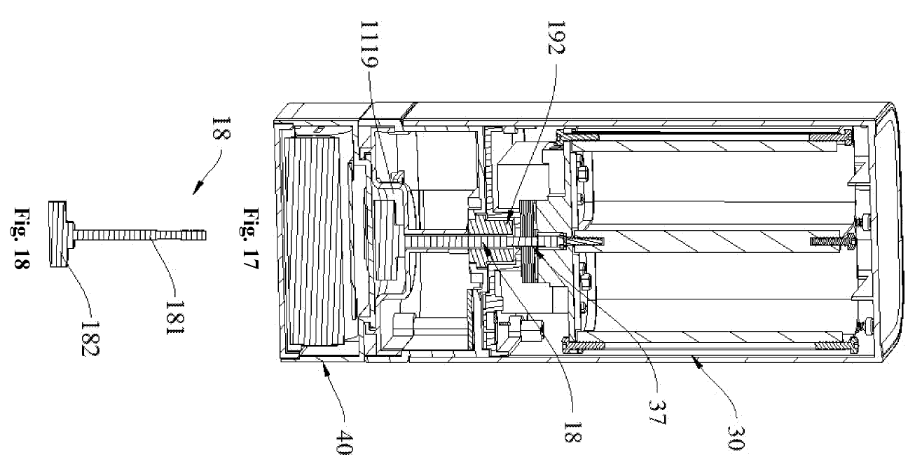

FIGS. 1 to 23 show some embodiments of a modular oxygen concentrator of this disclosure. The modular oxygen concentrator in one or more embodiments of this disclosure has a highly modular and convenient detachment design, which not only facilitates maintenance and replacement of components, but also greatly improves use flexibility and portability of the oxygen concentrator.

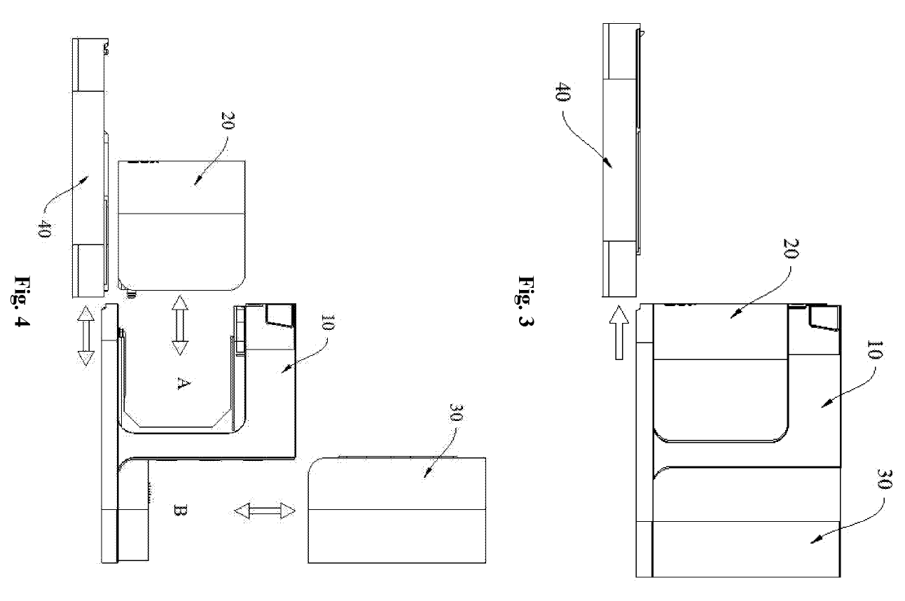

As shown in FIGS. 1 and 2, the oxygen concentrator in some embodiments is a modular oxygen concentrator, and includes a main frame module 10 and various functional modules that can be detached from and attached to the main frame module 10, and the various functional modules include a compressor module 20, a molecular sieve module 30, and a battery module 40.

The main frame module 10 is a main body of the modular oxygen concentrator, and is mainly configured to connect and support the various functional modules.

The compressor module 20 includes a compressor shell assembly 21 and a compressor 22 disposed inside the compressor shell assembly 21, and the compressor 22 inhales and compresses outside air to a certain pressure to provide necessary power and pressure conditions for a subsequent air separation process.

The molecular sieve module 30 is a core part for achieving oxygen separation in the oxygen concentrator. A specific molecular sieve material is used to separate oxygen and nitrogen from the compressed air in accordance with the principle of adsorption and desorption.

The battery module 40 provides electric power support for the entire oxygen concentrator. A high-performance lithium battery or rechargeable battery pack is usually adopted to ensure that the oxygen concentrator can still operate continuously in a power-off or mobile environment. The battery module 40 not only supplies electric power to key components such as the compressor 22 and a molecular sieve tank, but also ensures a portability and an endurance ability of the oxygen concentrator, so that the battery module 40 is suitable for various scenarios and user requirements.

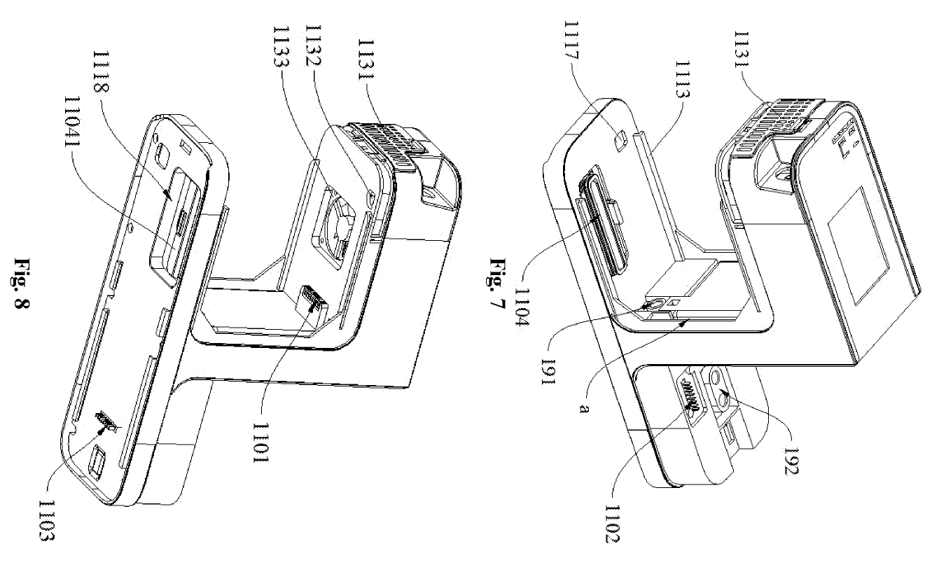

As shown in FIG. 6, the main frame module 10 includes a main frame 11, and an oxygen storage tank 14 and a control assembly 12 disposed inside the main frame 11. The main frame 11 is a main support structure. The oxygen storage tank 14 is connected to the molecular sieve module 30 to store generated oxygen. The control assembly 12 is used to electrically control the oxygen concentrator, and is responsible for controlling a working process of the entire oxygen concentrator and a coordinated operation of various modules.

Referring to FIG. 5, the compressor module 20 is located on one side of the main frame 11, and is slidably and detachably connected to the main frame 11 by a first detachment structure C1.

The molecular sieve module 30 is located on another side of the main frame 11, and is slidably and detachably connected to the main frame 11 by a second detachment structure C2.

The battery module 40 is located on a lower side of the main frame 11, and is slidably and detachably connected to the main frame 11 by a third detachment structure.

The compressor module 20, the molecular sieve module 30, and the battery module 40 are electrically connected to the main frame module 10 by electrical socket structures, respectively. Each of the electrical socket structures not only has a simple design, but also has a function of quick connection and disconnection, thereby ensuring that each of the functional modules can be electrically connected to the main frame module 10 quickly and stably.

As shown in FIG. 7, the main frame module 10 is provided with a compressor air receiving seat 191 interfacing with an air outlet of the compressor module 20, and is further provided with a molecular sieve air receiving seat 192 interfacing with an air inlet and an air outlet of the molecular sieve module 30. The compressor air receiving seat 191, the molecular sieve air receiving seat 192, and the oxygen storage tank 14 are connected in sequence by a pipeline to be in air communication. After the compressor module 20 and the molecular sieve module 30 are slidably attached, a quick connection can be realized by the compressor air receiving seat 191 and the molecular sieve air receiving seat 192, and the compressor air receiving seat 191 and the molecular sieve air receiving seat 192 are then connected to the oxygen storage tank 14 by the pipeline, thereby ensuring a smooth flow of air and efficient execution of an oxygen separation process.

According to the modular design of the above modular oxygen concentrator, the compressor module 20, the molecular sieve module 30, and the battery module 40 can be independently attached and quickly detached, which not only improves independence of respective functional modules, but also greatly simplifies maintenance and replacement operations of the oxygen concentrator. In an actual use, when a module fails or needs to be replaced periodically, a user can replace the corresponding module separately according to the needs without complex detaching or repair of the entire equipment, which not only reduces maintenance costs and a downtime, but also improves a long-term use stability of the oxygen concentrator.

In addition, the modular design also greatly improves a scalability and an adaptability of the oxygen concentrator. A user can select the compressor module 20, the molecular sieve module 30, and the battery module 40 of different specifications according to actual requirements, so that functions of the equipment can be flexibly adjusted according to environmental changes or different usage scenarios. For example, in a static application scenario, the user may need a stronger endurance ability, and may select the battery module 40 with a larger capacity, whereas in a scenario in which oxygen needs to be supplied efficiently, the user may need to select the compressor module 20 with a larger power and/or the molecular sieve module 30 with a higher efficiency. Such a module selection with high flexibility enables the oxygen concentrator to be widely used in different fields such as homes, hospitals, wilderness, and emergency rescue.

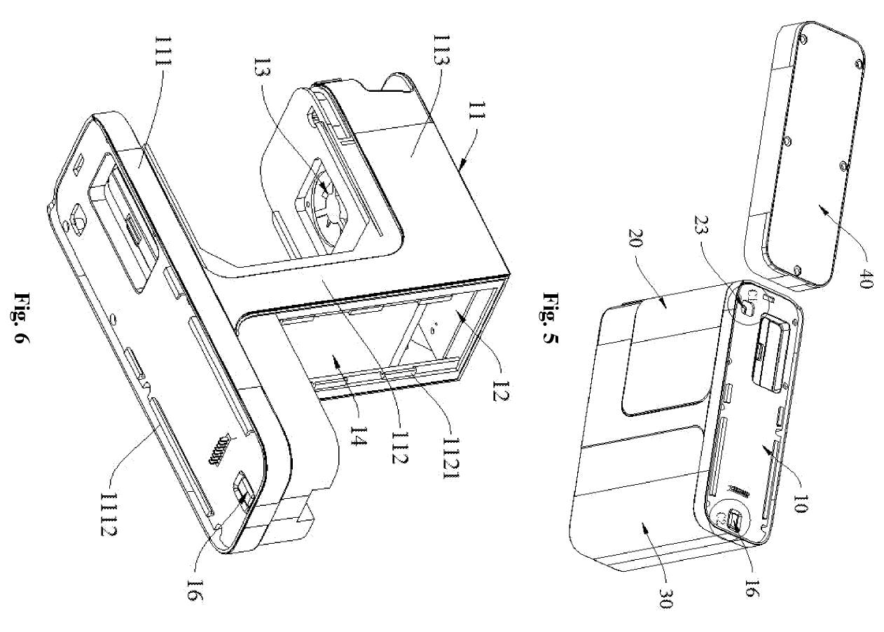

In some embodiments of this application, as shown in FIG. 4, one side of the main frame 11 is a side opening structure, a second sliding groove structure is provided between an upper end and/or a lower end of the side opening structure and the compressor module 20, and the compressor module 20 can be detached and attached in a horizontal direction by the second sliding groove structure.

The other side of the main frame 11 is a semi-open structure, the molecular sieve module 30 is disposed in the semi-open structure, a third sliding groove structure is disposed between a side surface of the semi-open structure and the molecular sieve module 30, and the molecular sieve module 30 can be detached and attached in a vertical direction by the third sliding groove structure.

Specifically, reasons for the compressor module 20 to be detached from and attached to the main frame 11 horizontally by the side opening structure and the molecular sieve module 30 to be detached from and attached to the main frame 11 vertically by the semi-open structure are as follows.

The compressor substantially is a member placed horizontally, and it is more convenient for the compressor to be attached horizontally, and at the same time, it is usually necessary to provide a corresponding fan assembly and a corresponding air inlet structure above the compressor module 20 for heat dissipation and air intake of the compressor module 20, and thus a space for attaching structures needs to be provided above the compressor module, and since the compressor module 20 vibrates during the operation, the engagement and horizontal placement of the side opening structure can effectively ensure the stability of the compressor module after attaching.

A functional effect of the molecular sieve module 30 is mainly related to a filling amount of a molecular sieve, that is, the more the molecular sieve is filled, the better the treatment effect, and thus, a length of the molecular sieve module 30 can be greatly extended in combination with the semi-open structure. Meanwhile, the semi-open structure also facilitates the overall detachment and attachment of the molecular sieve module in later stages. In addition, the accuracy and the reliability of the molecular sieve module during air path interfacing need to be considered. Compared with other forms, the vertical attaching mode can avoid an influence of reduced interfacing accuracy due to a weight of the molecular sieve itself, thereby improving an airtight effect.

Further, in combination with the disposing basis of the above structure, the attaching and detaching modes of the battery module 40 are designed. Specifically, as shown in FIG. 3, a first sliding groove structure is provided between the battery module 40 and a bottom surface of the main frame 11, and the battery module 40 can be detached and attached in the horizontal direction by the first sliding groove structure.

The battery module 40 is attached at the bottom surface of the main frame 11 for two reasons. Firstly, attachment is convenient and detachment can be performed quickly without affecting the compressor module 20 and the molecular sieve module 30 during the detachment, and secondly, a corresponding logic design is performed for a detachment step to reduce an equipment risk.

Specifically, when the battery module 40 is not detached, the first detachment structure C1 and the second detachment structure C2 are in a locked state to ensure a stable connection between the modules. After the battery module 40 is detached, the first detachment structure C1 and the second detachment structure C2 can be released from the locked state, and the user is allowed to freely attach and detach the compressor module 20 and the molecular sieve module 30.

Phenomenons of electricity leakage and air leakage are avoided in principle, after the battery module 40 is detached, the entire equipment components are in a power-off state, and the equipment does not operate, and in this case, the detachment and attachment of the compressor module 20 and the molecular sieve module 30 are very safe and reliable.

Specifically, referring to FIG. 6, the main frame 11 includes a base portion 111, a vertical frame portion 112, and an upper frame portion 113.

The base portion 111 is used to support the entire structure, the vertical frame portion 112 is vertically disposed on the base portion 111, and the upper frame portion 113 is connected to a top end and located on one side of the vertical frame portion 112 to form a top structure of the oxygen concentrator.

In order to achieve modular attachment of the compressor module 20 and the molecular sieve module 30, as shown in FIG. 4, a first region A is formed on one side of the vertical frame portion 112 and between a bottom surface of the upper frame portion 113 and the base portion 111, and forms the side opening structure, and the compressor module 20 is attached in the first region A. A second region B is formed between another side of the vertical frame portion 112 and the base portion 111 and forms the semi-open structure, and the molecular sieve module 30 is attached in the second region B. The semi-open structure allows a large size of the molecular sieve module 30, thereby improving an oxygen generation efficiency.

The oxygen storage tank 14 is vertically disposed in the vertical frame portion 112 of the main frame 11, so that the oxygen storage tank 14 can be compactly disposed in the main frame 11, thereby saving a lateral space of the equipment.

Further, referring to FIGS. 3 and 4, when the oxygen concentrator is assembled, it is necessary to first assemble the compressor module 20 and the molecular sieve module 30, and then insert the compressor module 20 and the molecular sieve module 30 into the main frame 11. As shown in FIG. 4, the compressor module 20 is horizontally inserted into the first region A of the main frame 11 by moving to the right, and is fixed to the main frame 11 by the first detachment structure C1, the molecular sieve module 30 is pressed into the second region B on a right side of the main frame 11 from top to bottom, and is fixed to the main frame 11 by the second detachment structure C2, and finally, the battery module 40 is slid into the bottom of the main frame 11 from left to right, and is fixed to the main frame 11 by the third detachment structure.

Similarly, when the compressor module 20 and the molecular sieve module 30 are detached, a locked state of the third detachment structure needs to be released, and the battery module 40 is first detached by sliding to the left, and then, when the compressor module 20 is detached, the locked state of the first detachment structure C1 is released, and the compressor module 20 is horizontally dragged to the left, and when the molecular sieve module 30 is detached, the locked state of the second detachment structure C2 is released, and the molecular sieve module 30 is vertically moved to the upper side.

By designing the above attaching and detaching logic, the battery module 40 has to be detached before the compressor module 20 and the molecular sieve module 30 are detached. This design prevents the battery module 40 from being misoperated or damaged when the compressor module 20 and the molecular sieve module 30 are being detached, thereby improving the operation safety.

In the following description, a flowing path of an oxygen generation airflow of the modular oxygen concentrator of this application will be described in detail.

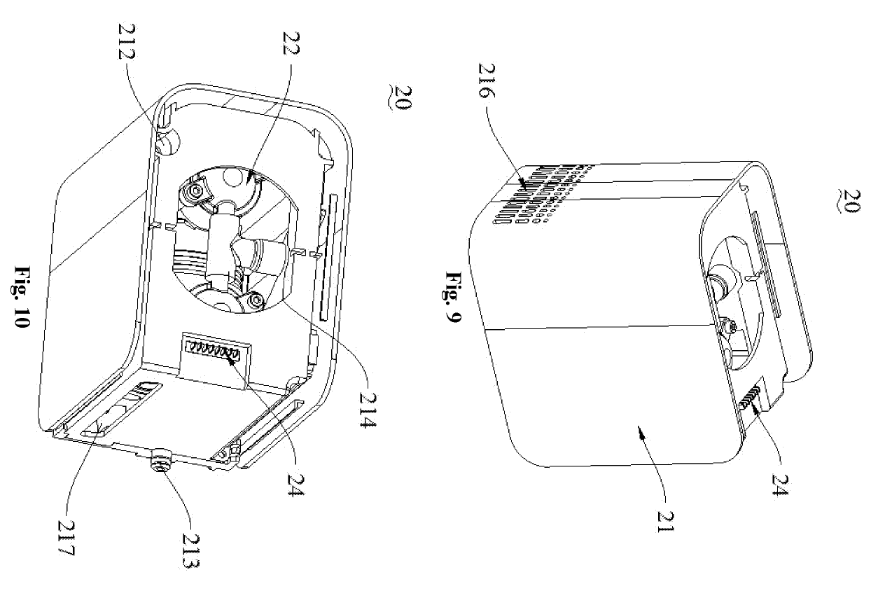

Referring to FIG. 8, an air inlet 1131 is provided in a side surface of the upper frame portion 113 of the main frame 11, and an air outlet hole 1132 is provided in a top surface of the side opening structure. The outside air enters through the air inlet 1131 and is discharged from the air outlet hole 1132 to form an oxygen generation airflow.

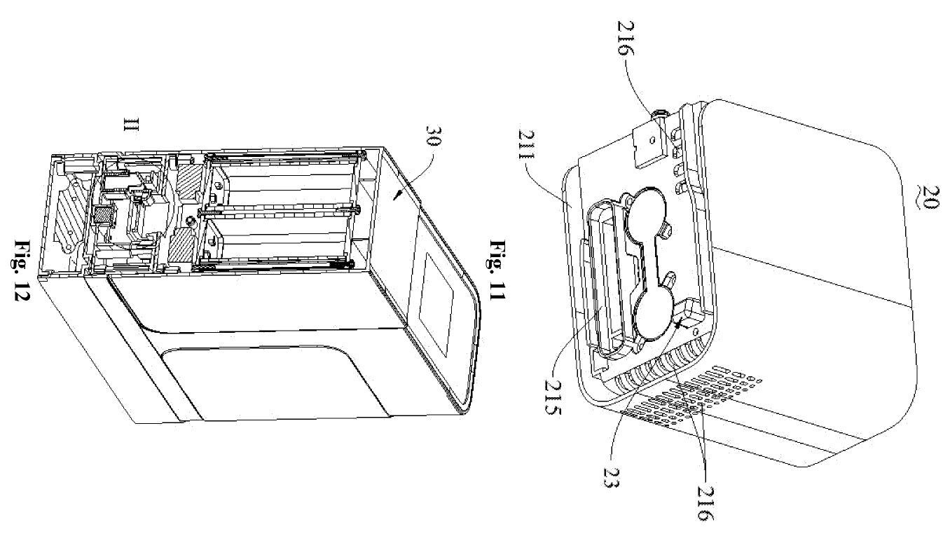

Referring to FIG. 10, a top of the compressor shell assembly 21 is provided with an air inlet cavity 212 corresponding to the air outlet hole 1132, an air guide pipe (not shown) is provided inside the compressor shell assembly 21, and the air inlet cavity 212 introduces the oxygen generation airflow into the compressor 22 through the air guide pipe.

The compressor air receiving seat 191 is provided at a bottom at an inner side of the side opening structure, and as shown in FIG. 7, the compressor air receiving seat 191 is provided at a bottom end of the vertical frame portion 112 of the main frame 11. A compressor air outlet interface 213 communicating with a compressor air discharge port protrudes from a side surface of the compressor module 20 located on the inner side of the side opening structure.

After the compressor module 20 is assembled in place in the horizontal direction, the compressor air outlet interface 213 is correspondingly inserted into the compressor air receiving seat 191 to achieve hermetic connection.

An air outlet end of the compressor air receiving seat 191 communicates with the molecular sieve air receiving seat 192 by a pipeline.

Referring to FIG. 7, the molecular sieve air receiving seat 192 is disposed on a bottom surface of the semi-open structure, that is, the molecular sieve air receiving seat 192 is disposed on the base portion 111 of the main frame 11. The molecular sieve air receiving seat 192 has an air inlet channel and an oxygen outlet channel. The air inlet channel communicates with the air outlet end of the compressor air receiving seat 191 by a pipeline, and the oxygen outlet channel is connected to the oxygen storage tank 14 by a pipeline.

Referring to FIG. 14, a molecular sieve air inlet interface 34 and a molecular sieve oxygen outlet interface 35 both protrude from a bottom of the molecular sieve module 30.

After the molecular sieve module 30 is assembled downward in place in the vertical direction, the molecular sieve air inlet interface 34 and the molecular sieve oxygen outlet interface 35 are respectively inserted into the air inlet channel and the oxygen outlet channel in the molecular sieve air receiving seat 192 to achieve the hermetic connection.

The specific flowing path of the oxygen generation airflow is as follows. After being compressed by the compressor 22, the oxygen generation airflow is delivered into the molecular sieve module 30 through the compressor air discharge port, the compressor air outlet interface 213, the compressor air receiving seat 191, the air inlet channel of the molecular sieve air receiving seat 192, and the molecular sieve air inlet interface 34, and oxygen and nitrogen are separated by the molecular sieve module 30. The separated oxygen is delivered to the oxygen storage tank 14 for storage through the molecular sieve oxygen outlet interface 35 and the oxygen outlet channel of the molecular sieve air receiving seat 192, and then is output to an oxygen injection valve from an oxygen outlet at a top of the oxygen storage tank 14, and the oxygen is output if it is detected that the user inhales. The nitrogen generated by the molecular sieve module 30 is discharged through the nitrogen discharge port and a nitrogen discharge muffler.

In the following description, a circuit connection between the functional modules of the modular oxygen concentrator of this application will be described in detail.

Referring to FIGS. 8 and 10, in some embodiments of this application, the electrical socket structures for the compressor module 20 and the main frame module 10 include a first electrical connector 1101 and a second electrical connector 24.

As shown in FIG. 8, the first electrical connector 1101 is disposed on the bottom surface or the top surface of the side opening structure and electrically connected to the control assembly 12. As shown in FIG. 10, the second electrical connector 24 is disposed at a bottom or top of the compressor module 20 corresponding to the first electrical connector 1101. The first electrical connector 1101 and the second electrical connector 24 are one of a plug and a socket. After the compressor module 20 is assembled in place in the horizontal direction, the electrical connection is performed by laterally inserting the plug into the socket. In some embodiments, the first electrical connector 1101 is the socket, and the second electrical connector 24 is the plug.

Referring to FIGS. 7 and 14, in some embodiments of this application, the electrical socket structures for the molecular sieve module 30 and the main frame module 10 include a third electrical connector 1102 and a fourth electrical connector 36.

The third electrical connector 1102 is disposed on the bottom surface of the semi-open structure, that is, on the base portion 111 of the main frame 11, and is electrically connected to the control assembly 12. The fourth electrical connector 36 is disposed at the bottom of the molecular sieve module 30 corresponding to the third electrical connector 1102. The third electrical connector 1102 and the fourth electrical connector 36 are one of a plug and a socket. After the molecular sieve module 30 is assembled in place in the vertical direction, the electrical connection is performed by vertically inserting the plug into the socket. In some embodiments, the third electrical connector 1102 is the plug, and the fourth electrical connector 36 is the socket.

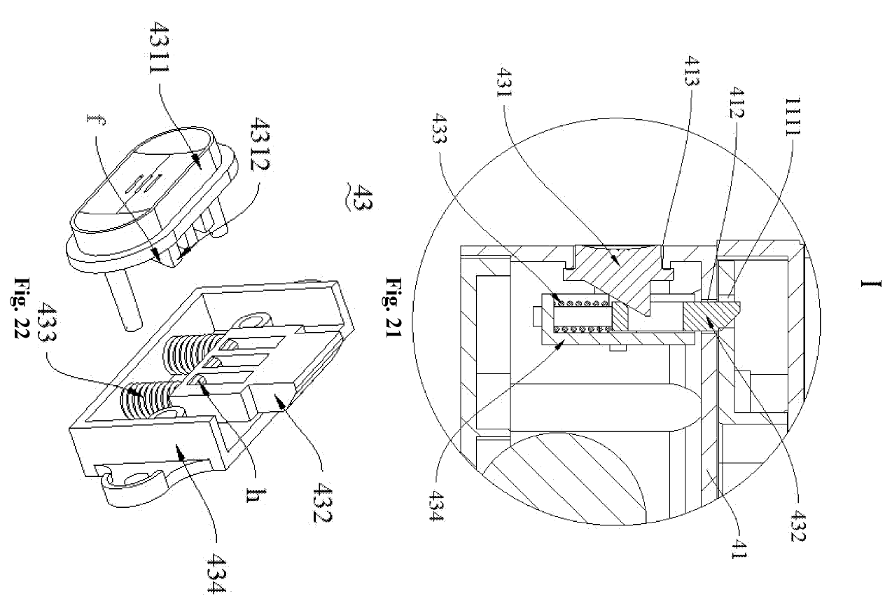

Referring to FIGS. 8 and 19, in some embodiments of this application, the electrical socket structures for the battery module 40 and the main frame module 10 include a fifth electrical connector 1103 and a sixth electrical connector 44.

The fifth electrical connector 1103 is disposed on the bottom surface of the main frame 11 and electrically connected to the control assembly 12. The sixth electrical connector 44 is disposed on a top of the battery module 40 corresponding to the fifth electrical connector 1103. The fifth electrical connector 1103 and the sixth electrical connector 44 are one of a plug and a socket. After the battery module 40 is assembled in place in the horizontal direction, the electrical connection is performed by laterally inserting the plug into the socket. In some embodiments, the fifth electrical connector 1103 is the plug, and the sixth electrical connector 44 is the socket.

In the following description, a sliding and detachment structure of the compressor module 20 will be described in detail.

In some embodiments of this application, the compressor module 20 is horizontally and slidably connected to a top surface of the base portion 111 by the second sliding groove structure. That is, the compressor module 20 is attached and detached in the horizontal direction.

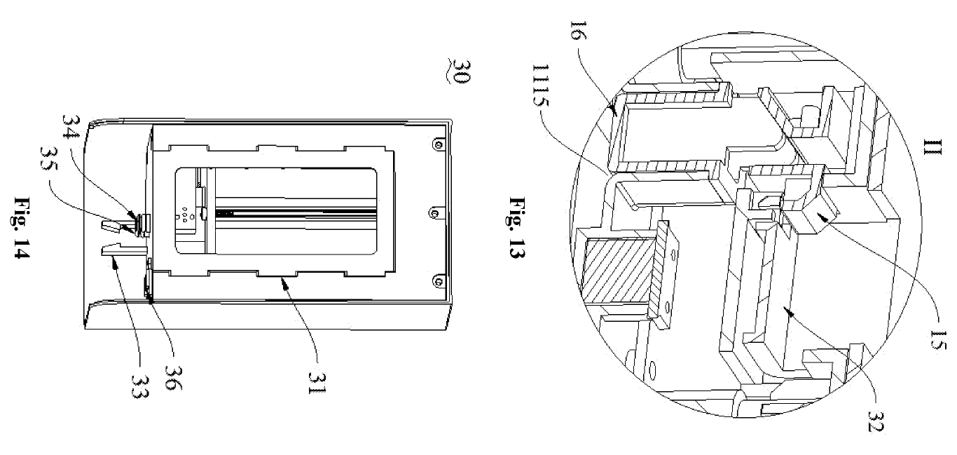

Specifically, as shown in FIGS. 7 and 11, the second sliding groove structure includes at least two second slot limiting members 1113 which are respectively disposed on the top surface of the base portion 111, and the two second slot limiting members 1113 are disposed opposite to each other. Limiting edges 211 extending downward are disposed on two opposite sides on the bottom of the compressor module 20, and the compressor module 20 can slide along the second slot limiting members 1113 by the limiting edges 211. Each of the limiting edges 211 is preferably disposed outside the second slot limiting member 1113. The second sliding groove structure not only guides the compressor module 20 to slide, but also limits other displacements of the compressor module 20 in the horizontal direction, and the displacement of the compressor module 20 in an up-down direction is limited by the structure of the main frame 11.

In some embodiments of this application, the first detachment structure C1 includes a filtering cavity opening 215 provided at the bottom of the compressor module 20, a main frame opening 1118 provided in the main frame 11, and a cover body 1104.

The filtering cavity opening 215 communicates with a filtering cavity located in the compressor module 20 to filter inlet air of the compressor 22. Filter cotton may be placed in the filtering cavity.

The cover body 1104 is detachably disposed at the filtering cavity opening 215 to open or close the filtering cavity.

The main frame opening 1118 is provided in the main frame 11, and an opening size of the main frame opening 1118 is adapted to the cover body 1104, so that the cover body 1104 can be detached or attached through the main frame opening 1118.

The cover body 1104 has a cover body extension portion 11041, and the cover body extension portion 11041 at least partially extends into the main frame opening 1118 to limit sliding movement between the compressor module 20 and the main frame 11.

In the case of attachment, the compressor module 20 is attached into the side opening structure of the main frame 11 along a sliding direction, a position of the filtering cavity opening 215 corresponds to a position of the main frame opening 1118 when installed in place, and then the cover body 1104 is attached through the main frame opening 1118, the filtering cavity opening 215 is closed by the cover body 1104, and the compressor shell assembly 21 and the main frame 11 are limited. In the case of detachment, the cover body 1104 is first detached by the main frame opening 1118, the position limitation on the compressor shell assembly 21 and the main frame 11 by the cover body 1104 is released, and then the compressor module 20 is detached from the side opening structure.

Further, the first detachment structure C1 further includes a limiting connector, and the limiting connector is disposed between the main frame 11 and the compressor module 20 to connect the main frame 11 and the compressor module 20. When only the cover body 1104 needs to be detached to clean or replace the filter cotton, the limiting connector can ensure stable connection between the compressor module 20 and the main frame 11. In some embodiments, the limiting connector is a quick release bolt.

In some other embodiments of this application, as shown in FIG. 11, the limiting connector is a compressor key 23, the compressor key 23 is disposed at the compressor module 20, the main frame 11 is provided with a limiting through hole 1117, and the compressor key 23 is fit and locked by being inserted into the limiting through hole 1117.

As shown in FIG. 7, the limiting through hole 1117 is disposed in the base portion 111 of the main frame 11 in a vertical penetrating manner. The compressor key 23 is disposed at the bottom of the compressor module 20. The compressor key 23 is locked by being inserted into the limiting through hole 1117. When being pressed, the compressor key 23 moves upward to exit the limiting through hole 1117, thereby releasing a locked state of the compressor key 23 and the limiting through hole 1117.

Further, the first detachment structure C1 further includes a spring (not shown), and the spring is connected to the compressor key 23 to keep the compressor key 23 in the locked state and to reset the compressor key 23 after being pressed.

By providing the first detachment structure C1, in a case of detaching the compressor module 20, the user only needs to detach the cover body 1104 and then press the compressor key 23 to easily remove the compressor module 20.

Since the compressor key 23 is disposed inside the base portion 111, after the battery module 40 is detached, the cover body 1104 can be detached through the main frame opening 1118 first, and then the compressor key 23 is pressed through the limiting through hole 1117 to quickly detach the compressor module 20.

In the following description, a sliding and detachment structure of the molecular sieve module 30 will be described in detail.

In some embodiments of this application, the molecular sieve module 30 is vertically and slidably connected to the side surface of the vertical frame portion 112 by the third sliding groove structure. That is, the molecular sieve module 30 is attached and detached in the vertical direction.

Specifically, as shown in FIGS. 6 and 14, the third sliding groove structure includes at least two third slot limiting members 1121 which are respectively disposed on the side surface of the vertical frame portion 112, and the two third slot limiting members 1121 are disposed opposite to each other to form sliding grooves. The side surface of the molecular sieve module 30 is provided with a third sliding portion 31, and the third sliding portion 31 is slidably attached in the sliding grooves and is engaged with the third slot limiting members 1121 to limit the displacement of the molecular sieve module 30 in a direction perpendicular to the sliding direction (horizontal direction).

In the case of the attachment, an operator only needs to slide the molecular sieve module 30 vertically along the third sliding groove structure, so that the molecular sieve module 30 can quickly reach an approximate attachment position, which greatly reduces an adjustment time and an adjustment difficulty during the attachment. After the molecular sieve module 30 slides into place, the second detachment structure C2 can quickly fix the molecular sieve module 30 on the main frame 11 to complete the attachment. In the case of the detachment, the second detachment structure C2 is released from the locked state first, and then the molecular sieve module 30 is slid out along the third sliding groove structure.

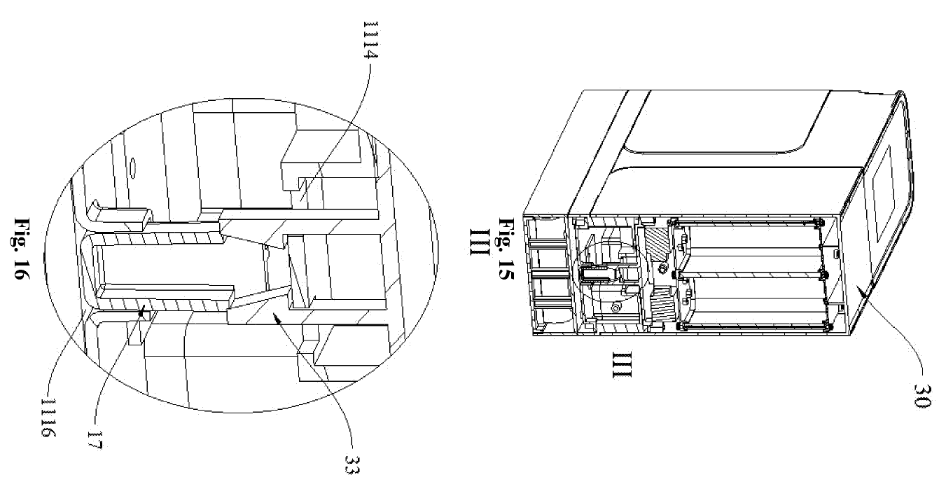

In some embodiments of this application, as shown in FIGS. 12 and 13, the second detachment structure C2 includes a locking groove 32 provided on the bottom surface of the molecular sieve module 30, and a locking member 15 and a molecular sieve key 16 provided on the base portion 111 of the main frame 11.

The locking member 15 and the molecular sieve key 16 are movably disposed on the main frame 11. Specifically, the bottom surface of the base portion 111 is provided with a molecular sieve key attachment hole 1115 for attaching the molecular sieve key 16, and the molecular sieve key 16 is disposed inside the molecular sieve key attachment hole 1115 in an up-down slidable manner. The locking member 15 is moved to lock the molecular sieve module 30 after engaging with the locking groove 32, and is released from the locked state after exiting the locking groove 32. In some embodiments, a detachment and attachment direction of the molecular sieve module 30 is perpendicular to a movable direction of the locking member 15.

According to the disposing of the second detachment structure C2, it is only necessary to align the molecular sieve module 30 with the main frame 11 and move the molecular sieve module 30 in place along the detachment and attachment direction, and then push the locking member 15 to be inserted into the locking groove 32 to complete the locking, and at the same time, the detachment and attachment direction of the molecular sieve module 30 is perpendicular to the movable direction of the locking member 15, so that a locking fit stability of the locking member 15 and the locking groove 32 is high, and a shaking gap after the molecular sieve module 30 is attached is reduced.

Since the molecular sieve key 16 is disposed on the bottom surface of the base portion 111, after the battery module 40 is detached, the molecular sieve module 30 can be quickly detached by pressing the molecular sieve key 16.

In some other embodiments of this application, as shown in FIGS. 14 to 16, the second detachment structure C2 includes an engagement pawl 33 provided on the bottom surface of the molecular sieve module 30, an engagement port 1114 provided on the base portion 111 and matching the engagement pawl 33, and a molecular sieve button 17 for releasing an engagement state of the engagement pawl 33 and the engagement port 1114.

The engagement pawl 33 extends along an attachment direction of the molecular sieve module 30, that is, the engagement pawl 33 is disposed vertically. The detachment and attachment direction of the molecular sieve module 30 is parallel to a movement direction when the molecular sieve button 17 releases the engagement.

By providing the second detachment structure C2, in a case of detaching the molecular sieve module 30, the user only needs to press the molecular sieve button 17 to easily remove the molecular sieve module 30, and the entire process does not need complex tools and professional maintenance skills, which greatly reduces an operation difficulty. In addition, this simple structure and clear movement mode ensure a reliability of a function of locking and unlocking the molecular sieve module 30 during the use of the oxygen concentrator, and are conducive to reducing faults.

In some embodiments, the base portion 111 is provided with a molecular sieve button attachment hole 1116 for attaching the molecular sieve button 17, and since the molecular sieve button 17 is disposed on the bottom surface of the base portion 111, after the battery module 40 is detached, the molecular sieve module 30 can be quickly detached by pressing the molecular sieve button 17.

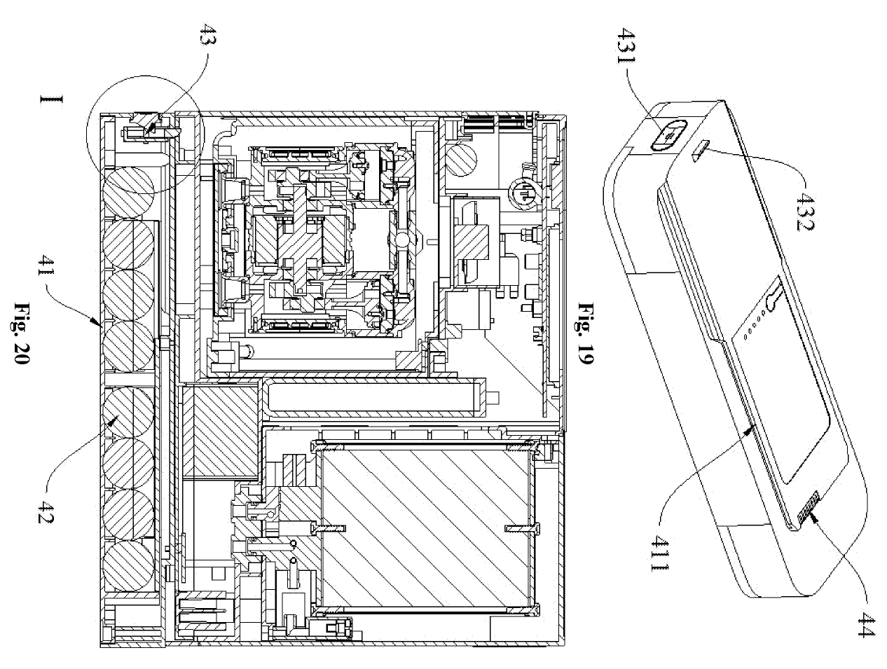

In some other embodiments of this application, as shown in FIGS. 17 and 18, the second detachment structure C2 includes a molecular sieve fastener 18 provided at the bottom of the main frame 11 and a fastening hole 37 provided in the molecular sieve module 30, and the fastening hole 37 matches the molecular sieve fastener 18. A rotation locking structure is adopted between the fastening hole 37 and the molecular sieve fastener 18, and the fastening hole 37 adopts a threaded hole, and an upper end of the molecular sieve fastener 18 adopts a matching external thread.

The molecular sieve fastener 18 is disposed vertically, and a through hole extending vertically and allowing the molecular sieve fastener 18 to penetrate through is provided in the molecular sieve air receiving seat 192. The molecular sieve fastener 18 penetrates through the molecular sieve air receiving seat, which is beneficial to the stability of the molecular sieve air inlet interface 34 and the molecular sieve oxygen outlet interface 35 inserted into the molecular sieve air receiving seat 192 after the molecular sieve module 30 is attached and fixed, and avoids a problem that a normal operation of the equipment is affected by air leakage due to the unstable connection between the molecular sieve air inlet interface 34 and the molecular sieve oxygen outlet interface 35.

The molecular sieve fastener 18 has a fastening column 181 and a handle 182 located at a lower end of the fastening column 181, and an accommodation groove 1119 for accommodating the handle 182 is provided at a lower end of the base portion 111. The accommodation groove 1119 provides a space for placing the handle 182, so that the structure is more compact and reasonable. A connection hole is opened between the through hole and the accommodation groove 1119, and the through hole and the connection hole are coaxially disposed. The molecular sieve fastener 18 penetrates through the accommodation groove 1119, the connection hole, and the through hole from the bottom to the top, and then is fastened into the fastening hole 37, so that a penetrating path of the molecular sieve fastener 18 is smooth, which is conducive to the attachment operation in a reasonable order, and ensures that the entire connection and fixing process can be completed efficiently and accurately.

In the following description, a sliding and detachment structure of the battery module 40 will be described in detail.

In some embodiments of this application, referring to FIGS. 6 and 19, the first sliding groove structure includes at least two first slot limiting members 1112 that are respectively disposed on the bottom surface of the base portion 111, and the two first slot limiting members 1112 are disposed opposite to each other to form sliding grooves. The battery module 40 is provided with a sliding portion 411, and the sliding portion 411 is slidably attached in the sliding grooves and is engaged with the first slot limiting member 1112 to limit the displacement of the battery module 40 in the direction perpendicular to the sliding direction. By designing such a structure including two limiting members and the sliding grooves, the stability of the sliding connection of the battery module 40 is effectively improved, and the tilting or shaking of the battery module 40 due to an external force can be avoided, so that the battery module 40 can be more stably and reliably attached.

In some embodiments of this application, as shown in FIGS. 20 to 22, the third detachment structure includes a limiting slot 1111 disposed on the bottom surface of the main frame 11 and a quick detachment assembly 43 disposed on the battery module 40.

The battery module 40 includes a battery module outer shell 41 and a battery assembly 42 disposed inside the battery module outer shell 41. The quick detachment assembly 43 is attached in the battery module outer shell 41.

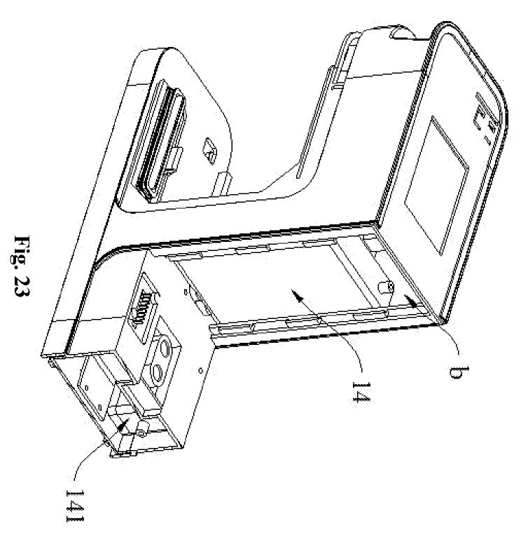

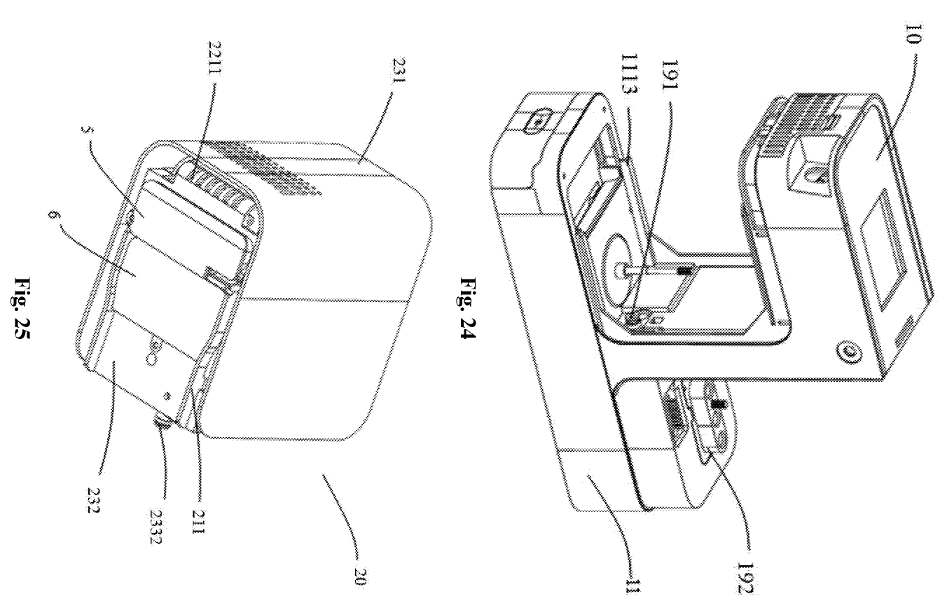

As shown in FIGS. 21 and 22, the quick detachment assembly 43 includes a battery key 431 and a snap 432. As shown in FIG. 21, the snap 432 is engaged with the limiting slot 1111 to limit the displacement of the battery module 40 in the sliding direction. The battery key 431 is configured to drive the snap 432 to move, so that the snap 432 exits the limiting slot 1111, thereby releasing the engagement state between the snap 432 and the limiting slot 1111.

Specifically, the snap 432 slides in a direction perpendicular to the sliding direction of the battery module 40, and is disposed inside the battery module outer shell 41. The battery module outer shell 41 is provided with a through hole 412 opposite to the limiting slot 1111, and the snap 432 protrudes through the through hole 412 to be engaged with the limiting slot 1111. The battery key 431 is located on one side of the snap 432, and the battery key 431 is pressed to drive the snap 432 to exit the limiting slot 1111, thereby completing a quick detachment operation of the battery module 40.

The battery module outer shell 41 is provided with a battery key attachment hole 413, the battery key 431 is attached in the battery key attachment hole 413, and a pressing direction of the battery key 431 is perpendicular to a sliding direction of the snap 432. In some embodiments, the battery key 431 is attached to a side surface of the battery module outer shell 41, and the pressing direction of the battery key 431 is perpendicular to the side surface of the battery module outer shell 41, which facilitates applying an external force to the battery key 431.

Further, the quick detachment assembly 43 further includes an elastic member 433, and the elastic member 433 is connected to the snap 432, and is configured to keep the snap 432 engaged with the limiting slot 1111 when the battery key 431 is not pressed, and to automatically reset the snap 432 after the battery key 431 is released. The adoption of the elastic member 433 greatly improves the operation safety and convenience of the quick detachment assembly 43, and can automatically return to an initial state without requiring any additional steps after the user completes the operation, thereby preventing a problem that the battery module 40 cannot be properly locked due to an improper operation.

Referring to FIG. 22, the battery key 431 includes a battery key main body 4311 and a force applying portion 4312 protruding from the battery key main body 4311, and the force applying portion 4312 has a force applying inclined surface f which is disposed obliquely. The snap 432 has a receiving surface h matching the force applying inclined surface f, and the battery key 431 drives the snap 432 to move in a direction away from the limiting slot 1111 by the interaction of the force applying inclined surface f and the receiving surface h.

In some embodiments of this application, the quick detachment assembly 43 further includes an attachment seat 434, the attachment seat 434 is fixedly connected to the battery module outer shell 41, and the snap 432 and the battery key 431 are both slidably disposed on the attachment seat 434. The attachment seat 434 provides a stable working platform for the snap 432 and the battery key 431, and at the same time, the snap 432 and the battery key 431 can be assembled prior to the attachment seat 434 and then integrally attached to the battery module outer shell 41, thereby improving an assembly and disassembly efficiency.

In the following description, a flowing path of a heat dissipation airflow of the modular oxygen concentrator of this application will be described in detail.

In some embodiments of this application, as shown in FIGS. 6 and 8, in order to dissipate heat of the compressor module 20, an air outlet 1133 is further disposed on the bottom surface of the upper frame portion 113 and the top surface of the side opening structure of the main frame 11, a fan 13 is disposed inside the upper frame portion 113 on an inner side of the air outlet 1133, and the fan 13 can drive air to enter through the air inlet 1131 and be discharged from the air outlet 1133.

The airflow entering through the air inlet 1131 and discharged from the air outlet 1133 forms the heat dissipation airflow, and the top of the compressor shell assembly 21 is provided with an air inlet region 214 corresponding to the air outlet 1133, and as shown in FIG. 10, the heat dissipation airflow flows into the compressor shell assembly 21 through the air inlet region 214 to dissipate heat of the compressor 22 inside the compressor module 20.

That is, in some embodiments, a part of the outside air entering through the air inlet 1131 is discharged from the air outlet hole 1132 to form the oxygen generation airflow, and a part of the outside air is discharged from the air outlet 1133 to form the heat dissipation airflow.

After the heat dissipation airflow entering the compressor module 20 dissipates the heat of the compressor 22, hot air can be divided into two parts to be output, that is, one part is discharged to the outside, and the other part flows to the molecular sieve module 30 for heating the molecular sieve inside the molecular sieve module 30.

Specifically, as shown in FIGS. 10 and 11, the compressor shell assembly 21 is provided with an external heat dissipation port 216 and an internal heat dissipation port 217, a part of the heat dissipation airflow is output to the outside from the external heat dissipation port 216, and a part of the heat dissipation airflow flows to the molecular sieve module 30 through the internal heat dissipation port 217 to heat the molecular sieve inside the molecular sieve module 30, and then is discharged to the outside through the internal heat dissipation port 217 and the external heat dissipation port 216, and the nitrogen discharged from the molecular sieve module 30 is also discharged through the external heat dissipation port 216 after being subjected to a muffling treatment.

When an ambient temperature of the oxygen concentrator is low, for example, in winter, an external temperature is low, a part of the heat dissipation airflow discharged from the compressor module 20 heats the molecular sieve module 30, so that the molecular sieve module 30 can work efficiently in a low-temperature environment. When the external temperature is high, the molecular sieve module 30 does not need to be heated, and a movable or detachable cover plate (not shown) is provided at the internal heat dissipation port 217 to close the internal heat dissipation port 217.

Referring to FIG. 7, a gap a is provided between the oxygen storage tank 14 and an inner wall of the vertical frame portion 112, and the first region A communicates with the second region B via the gap a. The heat dissipation airflow may flow to the molecular sieve module 30 through the internal heat dissipation port 217 and the gap a to perform temperature compensation and preheating on the molecular sieve module 30, thereby improving the working efficiency of the molecular sieve module 30.

In some embodiments of this application, the control assembly 12 includes a main control board, and a display and detection unit and an electronic control unit are integrated on the main control board.

The display and detection unit is responsible for a touch operation and data collection, so that the user can monitor a state of the oxygen concentrator in real time. Specifically, in some embodiments, a display screen is disposed on a top of the upper frame portion 113, and the display screen is located above the main control board. The display screen is a touch screen, so that the user can more conveniently view equipment state information, such as important parameters such as oxygen concentration, temperature, and pressure, by the display screen, and can perform simple controls on the equipment by touch.

The electronic control unit controls operation parameters of the oxygen concentrator, for example, electrically controls the fan 13, the compressor module 20, and the molecular sieve module 30 to ensure the stable operation of the system under different working conditions.

In addition, the main control board is disposed inside a heat dissipation air channel of the upper frame portion, and heat generated by the main control board can be taken away by air flowing in the air channel, so that a working temperature of the main control board can be effectively reduced, thereby extending a service life of the main control board and improving the stability and reliability of the system.

Referring to FIG. 23, the main frame module 10 is further provided with an auxiliary oxygen storage tank 141, and the auxiliary oxygen storage tank 141 is disposed inside the base portion 111 and is in series communication with the oxygen storage tank 14. The connection locations of these two tanks communicate with each other by a sealing rubber pad. The auxiliary oxygen storage tank 141 firstly fully utilizes a space in the existing structure of the equipment to increase air storage capacity, and secondly, provides additional oxygen to maintain stable oxygen supply when the equipment is under heavy load or has an increased oxygen demand.

This dual oxygen storage design greatly enhances a continuous oxygen supply capacity of the oxygen concentrator, and effectively alleviates a problem of insufficient oxygen supply of the equipment under high demand conditions by the coordinated operation of the oxygen storage tank 14 and the auxiliary oxygen storage tank 141. Meanwhile, the auxiliary oxygen storage tank 141 is disposed on the base portion 111, so that the structure of the equipment is more compact and reasonable, and a space utilization rate of the main frame module 10 is further improved.

As shown in FIG. 23, one end of the main control board is located above the oxygen storage tank 14, and since electronic components need to be attached to the main control board, a gap b is provided between a top of the oxygen storage tank and the main control board. Meanwhile, an auxiliary air inlet channel is provided at an upper portion of the molecular sieve module 30, an auxiliary air inlet 38 (as shown in FIG. 2) is provided in the outer shell of the molecular sieve module 30 to communicate with the auxiliary air inlet channel, the auxiliary air inlet channel communicates with the gap b, and a heat dissipation effect is achieved by using the auxiliary air inlet channel.

In one or more embodiments of this application, the oxygen concentrator may use a VPSA compressor, that is, a vacuum pressure swing adsorption compressor as the compressor 22. The VPSA compressor can first pressurize the air, then input the pressurized air into the molecular sieve, and use the molecular sieve to selectively adsorb impurities such as nitrogen, carbon dioxide, and water in the air, and the oxygen that is not easily adsorbed is output as product gas. Then, the VPSA compressor is used to extract nitrogen from the molecular sieve, and the previously adsorbed nitrogen is forcibly desorbed and evacuated as exhaust gas, thereby realizing a cyclic oxygen generation function. The VPSA compressor in some solutions may generate large noise in an air intake process and a nitrogen discharge process, and especially a portable medical oxygen concentrator has higher requirements for modularization and space utilization rate of products.

In one or more embodiments of this application, a modular design is performed in accordance with the features of the VPSA compressor, the air discharge muffling portion 6 and the air inlet muffling portion 5 are integrated, thereby improving a mute effect of the oxygen concentrator, and meanwhile, the hot air and nitrogen generated by the compressor 22 can also be uniformly discharged, so that the overall structure of the oxygen concentrator becomes more compact.

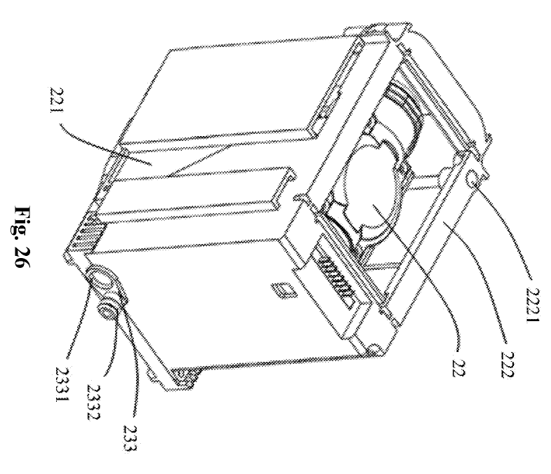

FIG. 24 is a perspective view of the main frame module 10 of the oxygen concentrator according to one or more embodiments of this application, and in the following description, a height direction of the main frame module 10 is defined as the up-down direction based on the drawing of FIG. 24 as a reference direction.

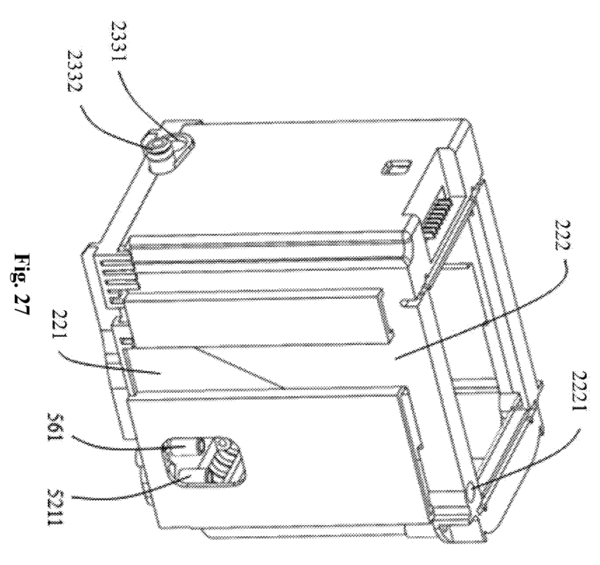

As shown in FIGS. 25 and 26, the compressor module 20 further includes the air inlet muffling portion 5 and the air discharge muffling portion 6 disposed at the bottom of the compressor shell assembly 21. The compressor 22 includes a positive pressure air inlet, a positive pressure air outlet, a negative pressure air inlet, and a negative pressure air outlet that are not shown in the drawing, the air inlet muffling portion 5, the positive pressure air inlet, the positive pressure air outlet, and the air inlet of the molecular sieve module 30 communicate with each other in sequence, and the nitrogen discharge port of the molecular sieve module 30, the negative pressure air inlet, the negative pressure air outlet, and the air discharge muffling portion 6 communicate with each other in sequence. The compressor 22 is specifically the VPSA compressor in which a blower and a vacuum pump are integrated, and can simultaneously exert a pressurization function and a vacuum function.

The working principle of the oxygen concentrator according to one or more embodiments of this application is as follows. The air enters the compressor module 20 and then enters the air inlet muffling portion 5, is output to the positive pressure air inlet of the compressor 22 after being muffled by the air inlet muffling portion 5, and then is discharged from the positive pressure air outlet after being pressurized by the compressor 22, and is output to the air inlet of the molecular sieve module 30. The nitrogen separated by the molecular sieve module 30 is discharged to the air discharge muffling portion 6 through the nitrogen discharge port of the molecular sieve module 30, the negative pressure air inlet, and the negative pressure air outlet under a negative pressure of the compressor 22, and is muffled by the air discharge muffling portion 6. Therefore, the oxygen concentrator according to one or more embodiments of this application can effectively reduce the noise generated by the air intake and nitrogen discharge performed by the compressor 22, improve a mute effect of the oxygen concentrator, and ensure that consumers have good experience in using oxygen generation. The air inlet muffling portion 5 and the air discharge muffling portion 6 are simultaneously integrated at the bottom of the compressor shell assembly 21, so that the structure of the compressor module 20 can be more compact.

As shown in FIGS. 26 and 27, the compressor shell assembly 21 is further provided with a compressor joint 233, an air outlet channel 2331 and a nitrogen inlet channel 2332 are provided in the compressor joint 233, the air outlet channel 2331 is configured to allow the positive pressure air outlet to communicate with the air inlet of the molecular sieve module 30, and the nitrogen inlet channel 2332 is configured to allow the negative pressure air inlet to communicate with the nitrogen discharge port of the molecular sieve module 30.

Further, as shown in FIG. 24, the main frame module 10 includes the main frame 11, and the compressor air receiving seat 191 and the molecular sieve air receiving seat 192 that are disposed on the main frame 11. The compressor air receiving seat 191 interfaces with the air outlet channel 2331 and the nitrogen inlet channel 2332 in the compressor joint 233, the molecular sieve air receiving seat 192 interfaces with the nitrogen discharge port, the oxygen outlet, and the air inlet of the molecular sieve module 30, and the compressor air receiving seat 191 and the molecular sieve air receiving seat 192 are connected by a pipeline to be in air communication.

Preferably, as shown in FIGS. 24 and 25, the main frame module 10 is provided with the at least two second slot limiting members 1113 disposed opposite to each other, the bottom of the compressor shell assembly 21 is further provided with the at least two limiting edges 211 extending downward, the second slot limiting members 1113 are in sliding fit with the limiting edges 211, and the compressor module 20 can slide to the left and right along the second slot limiting members 1113 by the limiting edges 211.

After the compressor module 20 is assembled in place on the main frame module 10, the compressor joint 233 is inserted into the compressor air receiving seat 191 to achieve hermetic connection, and quick connection with the molecular sieve module 30 can be achieved by the compressor air receiving seat 191 and the molecular sieve air receiving seat 192, thereby ensuring a smooth flow of air and efficient execution of the oxygen separation process.

As shown in FIG. 25, in order to prevent the disposing of the air discharge muffling portion 6 from affecting the assembling of the compressor module 20 and the main frame module 10, a bottom height of the air discharge muffling portion 6 is set to be greater than bottom surface heights of the limiting edges 211, that is, the limiting edges 211 extend downward below the bottom of the air discharge muffling portion 6.

As shown in FIGS. 25 to 28, the compressor shell assembly 21 specifically includes a compressor outer shell 231 and a compressor inner shell 232 disposed at an inner side of the compressor outer shell 231, and the compressor inner shell 232 includes a compressor bottom shell 221 and a compressor cover 222 connected to a top of the compressor bottom shell 221. The compressor 22 is disposed inside the compressor inner shell 232, the air inlet muffling portion 5, the air discharge muffling portion 6, and the limiting edges 211 are all disposed at a bottom of the compressor bottom shell 221, and the compressor joint 233 is disposed on one side of the compressor bottom shell 221.

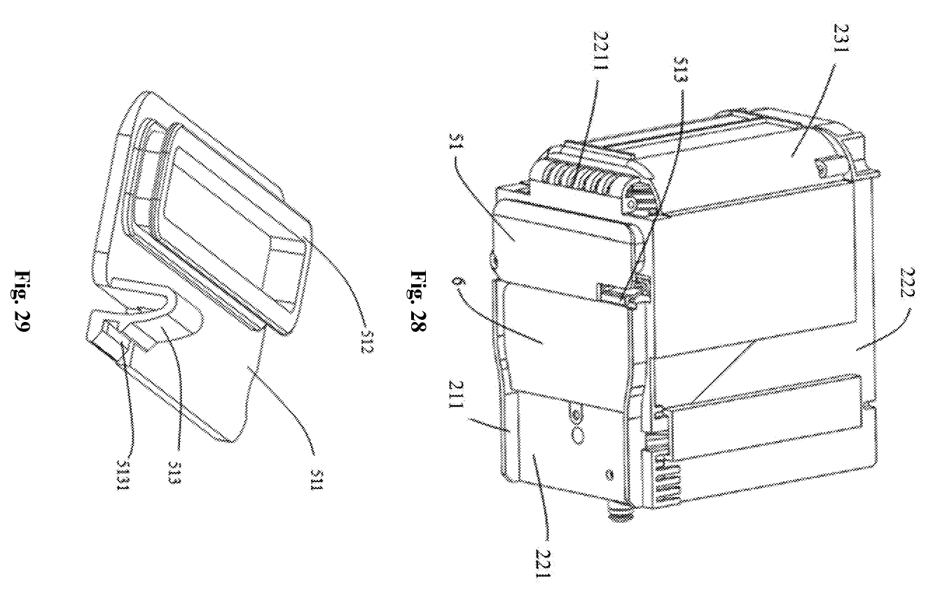

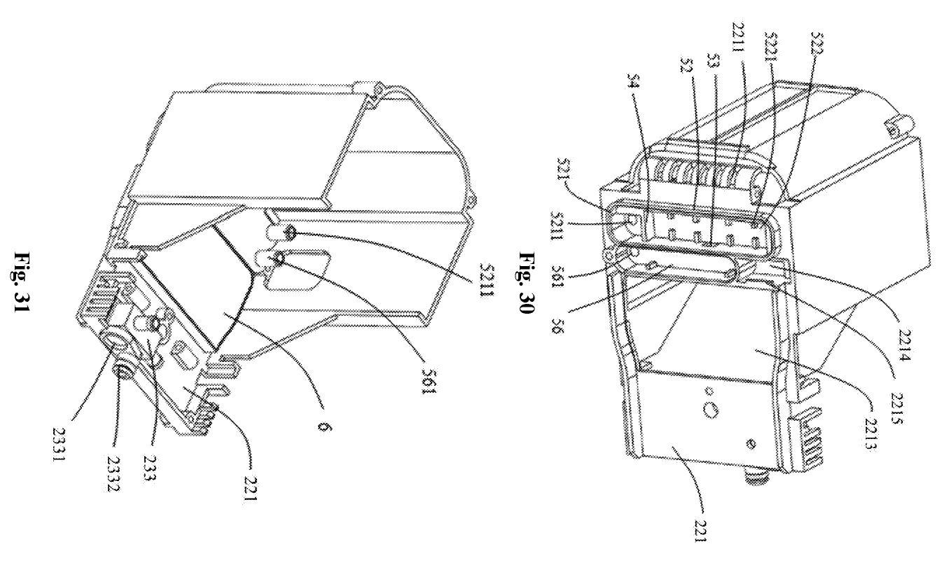

Further, as shown in FIGS. 28 and 30, the air inlet muffling portion 5 includes a first muffling cavity 52 and a second muffling cavity 56 both disposed at an outer side of the bottom of the compressor bottom shell 221 (that is, a side away from the compressor 22), and a muffling cover 51 covering bottoms of the first muffling cavity 52 and the second muffling cavity 56. A first air inlet hole 5211 and a communication hole 53 communicating with the second muffling cavity 56 are provided in the first muffling cavity 52, an air outlet hole 561 communicating with the positive pressure air inlet is provided in the second muffling cavity 56, and muffling cotton is further provided between the muffling cover 51 and the first muffling cavity 52. After entering the first muffling cavity 52 through the first air inlet hole 5211, the air enters the compressor 22 for compression through the muffling cotton, the communication hole 53, the second muffling cavity 56, and the air outlet hole 561. In one or more embodiments of this application, an air inlet path of the compressor 22 is extended by providing the first muffling cavity 52 and the second muffling cavity 56, and at the same time, the muffling cotton is added in the air inlet path to filter noise, thereby effectively reducing air inlet noise of the compressor 22.

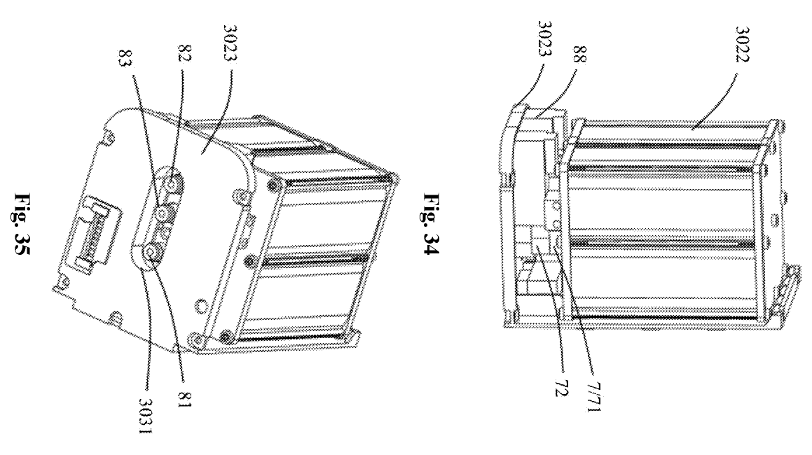

As shown in FIGS. 27, 31, and 33, the first air inlet hole 5211 and the air outlet hole 561 both extend upward into the compressor bottom shell 221. An air discharge grille 2211 is also provided on the compressor bottom shell 221. As shown in FIGS. 26 and 27, the top of the compressor cover 222 is provided with a second air inlet hole 2221 communicating with the first air inlet hole 5211, and the outside air enters the first air inlet hole 5211 through the second air inlet hole 2221.

As shown in FIGS. 27, 30, and 33, the airflow flowing path of the oxygen concentrator is specifically as follows. After entering the compressor module 20, the air enters the air inlet muffling portion 5 through the second air inlet hole 2221, a connection hose, and the first air inlet hole 5211, is filtered and muffled by the air inlet muffling portion 5, and then is output from the air outlet hole 561 to the positive pressure air inlet of the compressor 22, is pressurized by the compressor 22 and then discharged from the positive pressure air outlet, and then is output to the air inlet of the molecular sieve module 30 through the air outlet channel 2331, the compressor air receiving seat 191, and the molecular sieve air receiving seat 192. The nitrogen separated by the molecular sieve module 30 enters the negative pressure air inlet of the compressor 22 through the nitrogen discharge port of the molecular sieve module 30, the molecular sieve air receiving seat 192, the compressor air receiving seat 191, and the nitrogen inlet channel 2332 under the negative pressure of the compressor 22, and is discharged from the negative pressure air outlet of the compressor 22 to an air discharge muffling portion nitrogen inlet 61 on the air discharge muffling portion 6, and after being muffled in the air discharge muffling portion 6, the nitrogen is discharged into the compressor module 20 through the air discharge muffling portion nitrogen discharge port 62 on the air discharge muffling portion 6, and finally is discharged through the air discharge grille 2211 on the compressor bottom shell 221 and an air discharge grille on the compressor outer shell 231.

Further, as shown in FIGS. 28 and 30, a partition plate 54 is provided in the first muffling cavity 52, the partition plate 54 divides the first muffling cavity 52 into an air inlet cavity 521 and a filtering cavity 522, the first air inlet hole 5211 is provided in the air inlet cavity 521, the communication hole 53 is configured to allow the filtering cavity 522 to communicate with the second muffling cavity 56, and the muffling cotton is provided between the muffling cover 51 and the filtering cavity 522. The filtering cavity 522 is further provided with a plurality of support members 5221 spaced apart for supporting the muffling cotton. In one or more embodiments of this application, the first air inlet hole 5211 is separated from the filtering cavity 522 by the partition plate 54, so that after entering the air inlet cavity 521, the air needs to first move downward through a gap between the muffling cover 51 and the partition plate 54 to enter the filtering cavity 522 and the muffling cotton, and then penetrate from a lower portion to an upper portion of the muffling cotton to enter the communication hole 53 and then enter the second muffling cavity 56. Therefore, the disposing of the partition plate 54 helps to further extend the air inlet path of the compressor 22, so that the muffling cotton can fully exert the muffling function.

In order to facilitate the disposing of the muffling cotton, preferably, a cross-sectional area of the filtering cavity 522 is set to be greater than a cross-sectional area of the air inlet cavity 521.

As shown in FIGS. 28 to 30, the muffling cover 51 specifically includes a cover body 511 covering the bottoms of the first muffling cavity 52 and the second muffling cavity 56, and a cross-sectional area of the cover body 511 is not less than a sum of the cross-sectional areas of the first muffling cavity 52 and the second muffling cavity, and thus the cover body 511 can completely cover the openings in the bottoms of the first muffling cavity 52 and the second muffling cavity 56.

The muffling cover 51 is detachably attached at the bottom of the compressor bottom shell 221, and specifically, the cover body 511 is provided with an inverted U-shaped snap 513, the bottom of the compressor bottom shell 221 is further provided with a snap accommodation groove 2214, and the snap 513 is elastically engaged in the snap accommodation groove 2214. Preferably, a side wall of the snap accommodation groove 2214 is provided with an engagement protrusion 2215, and one side of the snap 513 is provided with a groove 5131 in insertion fit with the engagement protrusion 2215. When the muffling cover 51 is assembled, the snap 513 is first attached into the snap accommodation groove 2214, so that the engagement protrusion 2215 is inserted into the groove 5131, and the muffling cover 51 can be relatively fixed to seal the bottoms of the first muffling cavity 52 and the second muffling cavity 56. When the muffling cover 51 needs to be detached, the groove 5131 may be pushed away from the engagement protrusion 2215 by hands, so that the engagement protrusion 2215 is separated from the groove 5131, and the snap 513 can be separated from the accommodation groove. The muffling cover 51 can be conveniently detached and attached in this way, thereby facilitating replacement and daily cleaning of the muffling cotton.

Further, a ring-shaped cover body extension portion 512 protruding upward is further provided in a region on a top of the cover body 511 corresponding to the first muffling cavity 52, and the cover body extension portion 512 is embedded in the first muffling cavity 52 and closely abuts against an inner wall of the first muffling cavity 52. The muffling cotton is disposed on an inner side of the cover body extension portion 512 and in a region corresponding to the filtering cavity 522. Such disposing can achieve the hermetic connection between the cover body 511 and the first muffling cavity 52.

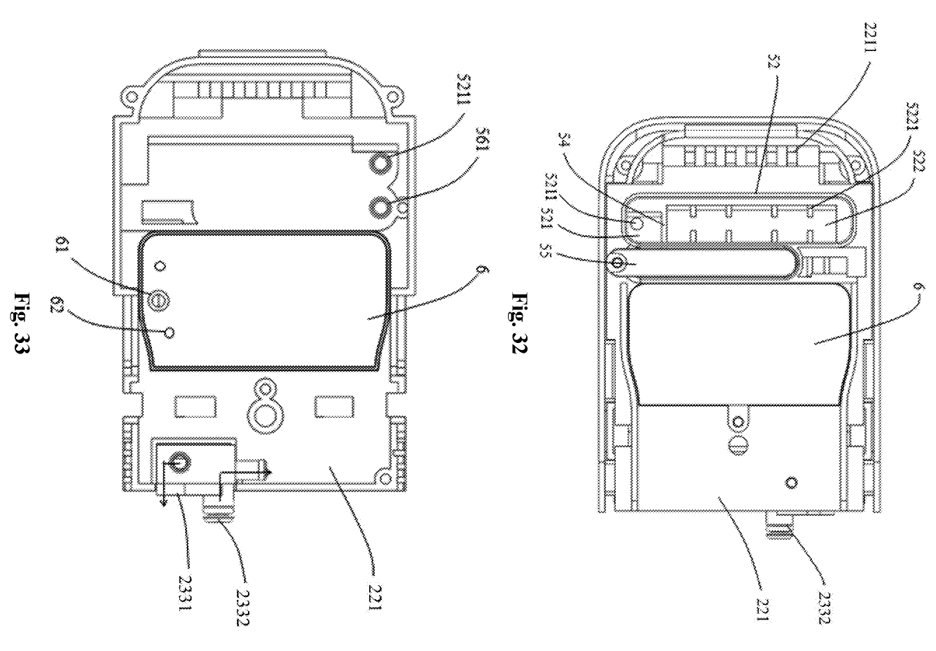

Further, in order to prevent the air in the second muffling cavity 56 from overflowing, as shown in FIG. 32, the air inlet muffling portion 5 further includes a sealing cover 55 hermetically connected to the second muffling cavity 56, and the sealing cover 55 is located above the muffling cover 51. Since the second muffling cavity 56 does not require frequent maintenance, the sealing cover 55 may be fixed to the compressor bottom shell 221 by a bolt.

As shown in FIG. 30, the bottom of the compressor bottom shell 221 is further provided with an air discharge attachment groove 2213 adjacent to the snap accommodation groove 2214, and the air discharge muffling portion 6 is detachably attached in the air discharge attachment groove 2213. In order to facilitate the detachment and attachment of the muffling cover 51, the bottom height of the air discharge muffling portion 6 is set to be greater than the bottom surface height of the snap 513, that is, the snap 513 extends downward below the air discharge muffling portion 6, thereby reserving a sufficient operation space for hands between the air discharge muffling portion 6 and the snap 513.

As shown in FIGS. 26 and 31, in order to ensure that the air discharge muffling portion 6 has a sufficient muffling cavity and to improve a muffling effect of the air discharge muffling portion 6, a top of the air discharge muffling portion 6 extends upward into the compressor bottom shell 221 and is located below the compressor 22. Such disposing helps to fully utilize an internal space of the compressor shell assembly 21 and improve a noise reduction effect of the oxygen concentrator.

In the above manner, in the oxygen concentrator according to one or more embodiments of this application, a modular design is performed in accordance with the features of the VPSA compressor, and the air discharge muffling portion 6 and the air inlet muffling portion 5 are integrated, thereby improving a mute effect of the oxygen concentrator, and meanwhile, the hot air and nitrogen generated by the compressor 22 can also be uniformly discharged, so that the overall structure of the oxygen concentrator becomes more compact.

In some embodiments of this application, in order to improve an detachment and attachment efficiency of the modular oxygen concentrator, an oxygen outlet pipe 81, a nitrogen discharge pipe 82, and an air inlet pipe 83 are integrated on one side to facilitate the detachment and attachment, and at the same time, it may difficult to align with holes during the attachment due to the addition of the interface, and thus one of these three pipes is used as a fixed structure to play a guiding and positioning role, and the other two pipes utilizes a movable gap to facilitate fine adjustment during the interfacing with the molecular sieve air receiving seat 192, thereby ensuring the reliability of the interfacing, and in addition, the assembly efficiency can be improved by reducing accuracy requirements during the processing. As shown in FIGS. 34 and 41, the molecular sieve module 30 includes a molecular sieve outer shell 3021, a molecular sieve cylinder 3022 in which a molecular sieve material is provided, a molecular sieve inner shell 3023 disposed at an inner side of the molecular sieve outer shell 3021 and configured to connect the molecular sieve cylinder 3022 and the molecular sieve outer shell 3021, and the air distribution valve 7 according to one or more embodiments of this application.

As shown in FIGS. 34 to 39, the air distribution valve 7 includes a valve seat 71, a seat interface 72, the oxygen outlet pipe 81, the nitrogen discharge pipe 82, and the air inlet pipe 83. The valve seat 71 is detachably disposed at the bottom of the molecular sieve cylinder 3022, and is provided with a first oxygen delivery pipeline 713 communicating with an oxygen outlet of the molecular sieve cylinder 3022, a nitrogen discharge pipeline 714 communicating with a nitrogen discharge port of the molecular sieve cylinder 3022, and an air inlet pipeline 715 communicating with an air inlet of the molecular sieve cylinder 3022. The seat interface 72 is detachably disposed at the bottom of the valve seat 71, and is provided with a first hole 722 and a second hole 723 penetrating up and down. The oxygen outlet pipe 81 is fixedly disposed on the seat interface 72 and communicates with the first oxygen delivery pipeline 713. The nitrogen discharge pipe 82 is attached in the first hole 722 in a limiting manner and has a gap with the first hole 722, and the nitrogen discharge pipe 82 is detachably connected to the valve seat 71 and communicates with the nitrogen discharge pipeline 714. The air inlet pipe 83 is attached in the second hole 723 in a limiting manner and has a gap with the second hole 723, and the air inlet pipe 83 is detachably connected to the valve seat 71 and communicates with the air inlet pipeline 715.

As shown in FIG. 24, the main frame module 10 includes the main frame 11 and the oxygen storage tank 14 disposed inside the main frame 11. The main frame 11 is a main support structure, and the oxygen storage tank 14 is connected to the molecular sieve module 30 to store oxygen separated by the molecular sieve module 30. Specifically, the main frame 11 is provided with the compressor air receiving seat 191 interfacing with the air outlet and a nitrogen inlet of the compressor module 20, and the molecular sieve air receiving seat 192 interfacing with the oxygen outlet pipe 81, the nitrogen discharge pipe 82, and the air inlet pipe 83, and the compressor air receiving seat 191, the molecular sieve air receiving seat 192, and the oxygen storage tank 14 are connected in sequence by a pipeline to be in air communication.

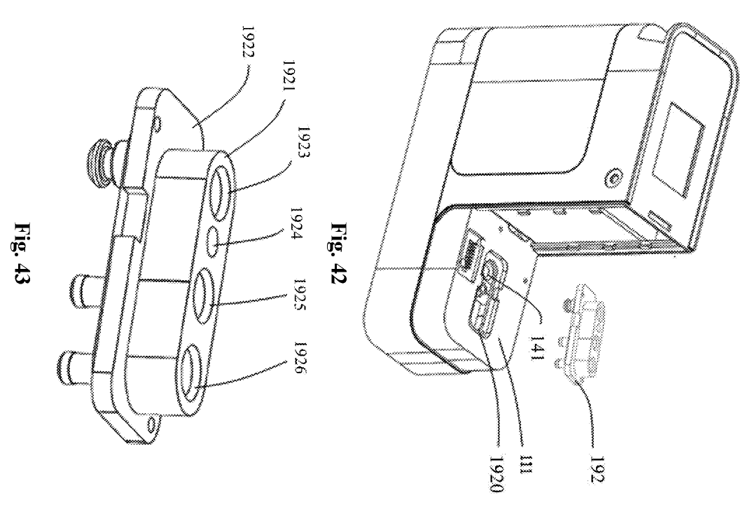

Specifically, as shown in FIGS. 42 and 43, the main frame 11 includes the base portion 111, and an air receiving seat attachment groove 1920 is provided in the base portion 111. The molecular sieve air receiving seat 192 includes a main body portion 1921 and an attachment plate 1922 disposed on an outer periphery of the main body portion 1921, and the attachment plate 1922 is embedded in the air receiving seat attachment groove 1920 and is detachably connected to the base portion 111. The main body portion 1921 is provided with an oxygen outlet channel 1923, a nitrogen discharge channel 1925, and an air inlet channel 1926. The air inlet channel 1926 is configured to allow the air outlet of the compressor 22 to communicate with the air inlet pipe 83, the nitrogen discharge channel 1925 is configured to allow the nitrogen inlet of the compressor module 20 to communicate with the nitrogen discharge pipe 82, and the oxygen outlet channel 1923 is configured to allow the oxygen storage tank 14 to communicate with the oxygen outlet pipe 81.

As shown in FIGS. 24, 35, and 41 to 43, after the molecular sieve module 30 is assembled in place on the base portion 111, the oxygen outlet pipe 81, the nitrogen discharge pipe 82, and the air inlet pipe 83 are respectively inserted into the oxygen outlet channel 1923, the nitrogen discharge channel 1925, and the air inlet channel 1926 in the molecular sieve air receiving seat 192 to achieve hermetic connection.

The specific flowing path of the oxygen generation airflow of the oxygen concentrator is as follows. After being compressed by the compressor 22, the oxygen generation airflow is delivered into the molecular sieve cylinder 3022 through the air outlet of the compressor module 20, the compressor air receiving seat 191, the air inlet channel 1926 of the molecular sieve air receiving seat 192, the air inlet pipe 83, and the air inlet of the molecular sieve cylinder 3022, and oxygen and nitrogen are separated by the molecular sieve material. The separated oxygen is delivered to the oxygen storage tank 14 for storage through the oxygen outlet of the molecular sieve cylinder 3022, the first oxygen delivery pipeline 713, the oxygen outlet pipe 81, and the oxygen outlet channel 1923 of the molecular sieve air receiving seat 192, and then is output to an oxygen injection valve from the oxygen outlet at the top of the oxygen storage tank 14, and the oxygen is output if it is detected that the user inhales. The separated nitrogen is discharged under the negative pressure of the compressor 22 through the nitrogen discharge port of the molecular sieve cylinder 3022, the nitrogen discharge pipeline 714, the nitrogen discharge pipe 82, the nitrogen discharge channel 1925 of the molecular sieve air receiving seat 192, and the external heat dissipation port 216 disposed on the shell of the compressor 22. Preferably, the oxygen storage tank 14 includes the oxygen storage tank 14 and the auxiliary oxygen storage tank 141, an oxygen inlet of the auxiliary oxygen storage tank 141 communicates with the oxygen outlet pipe 81 via the oxygen outlet channel 1923 of the molecular sieve air receiving seat 192, and an oxygen outlet of the auxiliary oxygen storage tank 141 communicates with the oxygen storage tank 14.

In one or more embodiments of this application, the air inlet pipe 83 and the nitrogen discharge pipe 82 of the air distribution valve 7 are detachably connected to the valve seat 71, and the air inlet pipe 83 and the nitrogen discharge pipe 82 are limited by the seat interface 72, while the movable gap is left between the seat interface 72 and the air inlet pipe 83 and the nitrogen discharge pipe 82, so that the air distribution valve 7 can accurately interface with the molecular sieve air receiving seat 192, and processing accuracy requirements for the oxygen concentrator can be effectively reduced.

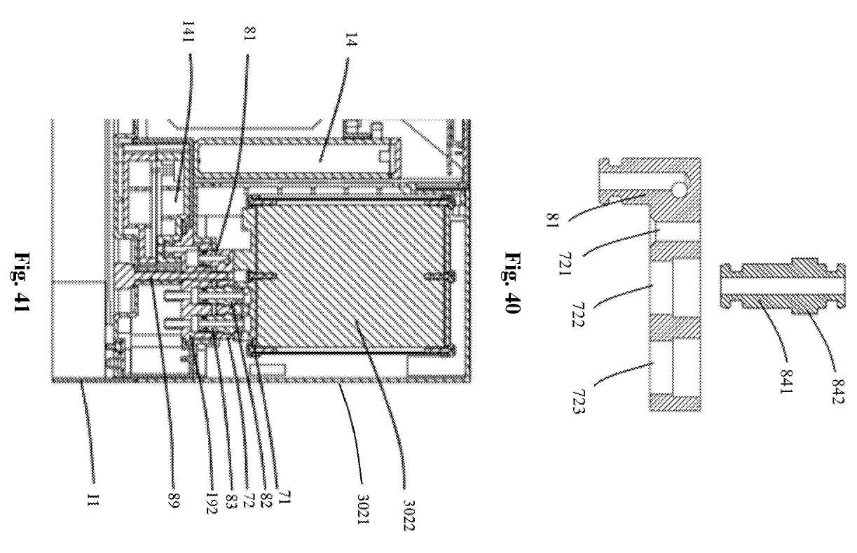

As shown in FIGS. 39 and 40, the first hole 722 and the second hole 723 are both stepped holes penetrating up and down, and each of the stepped holes includes a large-diameter portion (a portion with a larger hole diameter) and a small-diameter portion (a portion with a smaller hole diameter) that communicates from top to bottom in sequence. The nitrogen discharge pipe 82 and the air inlet pipe 83 each include a pipe body 841 and a protrusion 842 disposed on an outer periphery of the pipe body 841, and the protrusion 842 is in limiting fit with the large-diameter portion of the stepped hole, so that the pipe body 841 cannot be detached from the first hole 722 or the second hole 723. There is a gap between the pipe body 841 and the small-diameter portion of the stepped hole, and the gap allows the nitrogen discharge pipe 82 or the air inlet pipe 83 to slightly shake in the first hole 722 or the second hole 723, thereby satisfying interfacing requirements of the air distribution valve 7 and the molecular sieve air receiving seat 192.

Further, as shown in FIGS. 38 and 39, a lower end of the oxygen outlet pipe 81, and upper and lower ends of the nitrogen discharge pipe 82 and the air inlet pipe 83 are all engaged with sealing rings 87, and by disposing the sealing rings 87, the pipes can be the hermetically connected to the valve seat 71 and the molecular sieve air receiving seat 192 to prevent the air overflow.

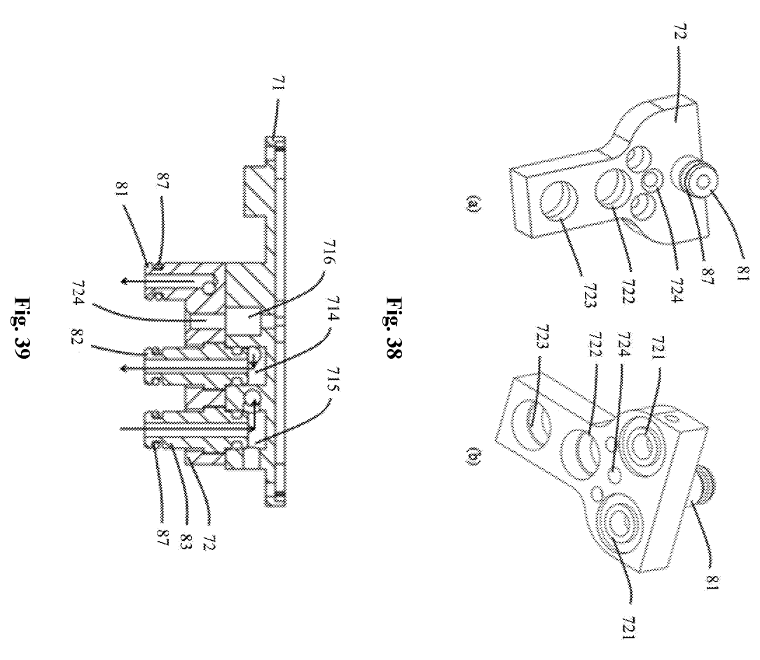

The first oxygen delivery pipeline 713, the nitrogen discharge pipeline 714, and the air inlet pipeline 715 may be disposed in the valve seat 71 in various forms. In one of the disposing forms, a hidden pipeline disposed in the valve seat 71 and an air path protrudes outward from the valve seat 71 are provided, and the air path is detachably connected to the oxygen outlet pipe 81, the nitrogen discharge pipe 82, or the air inlet pipe 83. In another disposing form as shown in FIGS. 37 and 38, hidden pipelines are provided in the valve seat 71 and communicate with each other, and exposed interfaces are provided. In a specific embodiment of this application, the nitrogen discharge pipeline 714 includes a first interface provided in the valve seat 71, and an upper end of the nitrogen discharge pipe 82 is inserted into the first interface, the air inlet pipeline 715 includes a second interface provided in the valve seat 71, and an upper end of the air inlet pipe 83 is inserted into the second interface, the first oxygen delivery pipeline 713 includes a third interface provided in the valve seat 71, and the seat interface 72 is provided with a second oxygen delivery pipeline 721 communicating with the oxygen outlet pipe 81, the second oxygen delivery pipeline 721 includes an extension portion provided at a bottom of the seat interface 72 and extending downward, and the extension portion is embedded in the third interface.

Since the air inlet and the oxygen outlet of the molecular sieve cylinder 3022 are both located at the bottom of the molecular sieve cylinder 3022, a one-way valve is provided in the first oxygen delivery pipeline 713 to prevent oxygen from flowing backwards into the oxygen outlet of the molecular sieve cylinder 3022. In addition, in order to facilitate the assembling of the molecular sieve module 30, the main body portion of the valve seat 71 is a rectangular cover shape, so that the valve seat 71 can be used as a bottom end cover of the molecular sieve cylinder 3022 to be hermetically connected to the bottom of the molecular sieve cylinder 3022.

Further, as shown in FIGS. 34, 36, and 37, the valve seat 71 is further provided with a pressure equalizing valve attachment hole 711 for attaching a pressure equalizing valve and a solenoid valve attachment hole 712 for attaching the solenoid valve 88. The seat interface 72 is preferably T-shaped, and is disposed away from the pressure equalizing valve attachment hole 711 and the solenoid valve attachment hole 712, thereby being beneficial to reducing a size of the air distribution valve 7 and saving an attachment space.

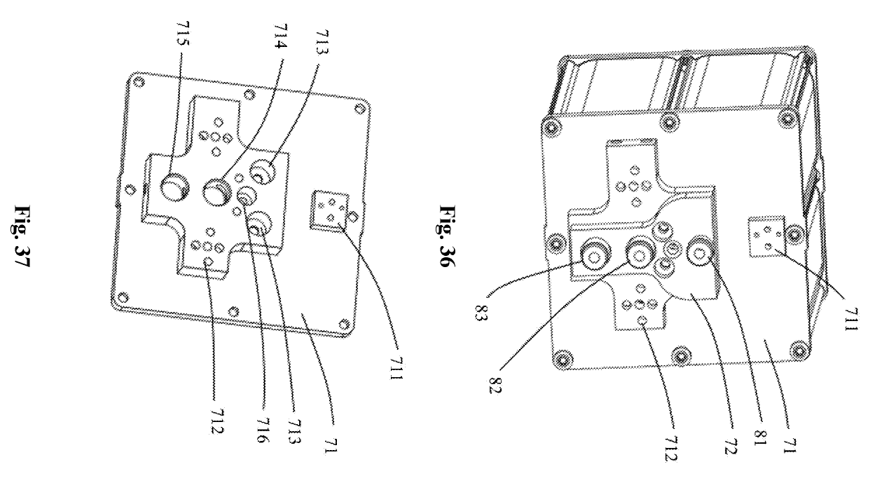

As shown in FIGS. 24 and 35, a slot 3031 is provided in the bottom of the molecular sieve inner shell 3023, and the oxygen outlet pipe 81, the nitrogen discharge pipe 82, and the air inlet pipe 83 all extend downward and penetrate through the slot 3031 to allow the interfacing with the molecular sieve air receiving seat 192 on the main frame 11.

As shown in FIGS. 37, 38, and 41, a first threaded hole is provided in the main frame module 10, a second threaded hole 1924 is further provided in the main body portion 1921 of the molecular sieve air receiving seat 192, a third threaded hole 724 is provided in the seat interface 72, and a fastener 89 penetrates through the first threaded hole, the second threaded hole 1924, and the third threaded hole 724 from bottom to top in sequence to securely connect the molecular sieve air receiving seat 192 and the seat interface 72 in the main frame module 10. Specifically, the fastener 89 is a screw. Meanwhile, a connection hole 716 is further provided in the valve seat 71, and is securely connected to the molecular sieve cylinder 3022 by the screw.

The one or more embodiments are merely used to describe the technical solutions of this disclosure, and are not intended to limit this disclosure. Although this disclosure has been described in detail with reference to the one or more embodiments, those skilled in the art can still modify the technical solutions described in the one or more embodiments, or equivalently replace some of the technical features, and these modifications or replacements do not make the essence of the corresponding technical solutions depart from the spirit and scope of the technical solutions claimed by this disclosure.

What is claimed is:

1. A modular oxygen concentrator comprising:
a main frame module including a main frame, and an oxygen storage tank and a control assembly disposed inside the main frame;
a compressor module located on one side of the main frame and slidably and detachably connected to the main frame by a first detachment structure;
a molecular sieve module located on another side of the main frame and slidably and detachably connected to the main frame by a second detachment structure; and
a battery module located on a lower side of the main frame and slidably and detachably connected to the main frame by a third detachment structure.

2. The modular oxygen concentrator according to claim 1, wherein
the first detachment structure and the second detachment structure are both located at a bottom of the main frame, and after the battery module is detached, the first detachment structure and the second detachment structure are released from a locked state.

3. The modular oxygen concentrator according to claim 1, wherein
a first sliding groove structure is provided between the battery module and a bottom surface of the main frame, and the battery module is detached and attached in a horizontal direction by the first sliding groove structure.

4. The modular oxygen concentrator according to claim 1, wherein
the one side of the main frame is a side opening structure, the compressor module is embedded in the side opening structure, a second sliding groove structure is provided between an upper end and/or a lower end of the side opening structure and the compressor module, and the compressor module is detached and attached in a horizontal direction by the second sliding groove structure.

5. The modular oxygen concentrator according to claim 4, wherein
the compressor module includes a compressor shell assembly and a compressor disposed inside the compressor shell assembly,
an upper side surface of the main frame is provided with an air inlet, and a top surface of the side opening structure is provided with an air outlet hole,
outside air enters through the air inlet and is discharged through the air outlet hole to form an oxygen generation airflow, and
a top of the compressor shell assembly is provided with an air inlet cavity corresponding to the air outlet hole, and the air inlet cavity introduces the oxygen generation airflow into the compressor through an air guide pipe.

6. The modular oxygen concentrator according to claim 5, wherein
the top surface of the side opening structure is further provided with an air outlet, and a fan is disposed inside the main frame at an inner side of the air outlet,
an airflow entering through the air inlet and discharged through the air outlet forms a heat dissipation airflow,
the top of the compressor shell assembly is provided with an air inlet region corresponding to the air outlet, and the heat dissipation airflow flows into the compressor shell assembly through the air inlet region, and
an external heat dissipation port is provided in the compressor shell assembly, and at least a part of the heat dissipation airflow is discharged to an outside through the external heat dissipation port.

7. The modular oxygen concentrator according to claim 6, wherein
an internal heat dissipation port is further provided in the compressor shell assembly, and a part of the heat dissipation airflow flows to the molecular sieve module through the internal heat dissipation port.

8. The modular oxygen concentrator according to claim 6, wherein
the control assembly is disposed on an upper portion of the main frame, and the heat dissipation airflow flows through the control assembly,
the oxygen storage tank is vertically disposed in the middle of the main frame,
the compressor module and the molecular sieve module are located on both sides of the oxygen storage tank, and
an auxiliary oxygen storage tank is provided at a bottom of the main frame, and the auxiliary oxygen storage tank is in series communication with the oxygen storage tank.

9. The modular oxygen concentrator according to claim 4, wherein
a compressor air receiving seat is disposed at a bottom at an inner side of the side opening structure,
a compressor air outlet interface communicating with a compressor air discharge port is provided on a side surface of the compressor module located on the inner side of the side opening structure, and
after the compressor module is installed in place in the horizontal direction, the compressor air outlet interface is correspondingly inserted into the compressor air receiving seat to achieve hermetic connection.

10. The modular oxygen concentrator according to claim 4, wherein
the compressor module includes a compressor shell assembly and a vacuum pressure swing adsorption compressor disposed inside the compressor shell assembly, and the vacuum pressure swing adsorption compressor includes a positive pressure air inlet, a positive pressure air outlet, a negative pressure air inlet, and a negative pressure air outlet,
the positive pressure air outlet communicates with an air inlet of the molecular sieve module, and
a nitrogen discharge port of the molecular sieve module communicates with the negative pressure air inlet.

11. The modular oxygen concentrator according to claim 10, wherein
the compressor module further includes an air inlet muffling portion and an air discharge muffling portion disposed at a bottom of the compressor shell assembly, the air inlet muffling portion communicates with the positive pressure air inlet, and the air discharge muffling portion communicates with the negative pressure air outlet.

12. The modular oxygen concentrator according to claim 10, further comprising:
an air distribution valve, wherein
the molecular sieve module is in air communication with the main frame module via the air distribution valve, the molecular sieve module includes a molecular sieve cylinder provided with a molecular sieve material inside, and the air distribution valve includes
a valve seat disposed at a bottom of the molecular sieve cylinder, and provided with a first oxygen delivery pipeline communicating with an oxygen outlet of the molecular sieve cylinder, a nitrogen discharge pipeline communicating with the nitrogen discharge port of the molecular sieve cylinder, and an air inlet pipeline communicating with an air inlet of the molecular sieve cylinder,
a seat interface provided on the valve seat and provided with two through holes,
an oxygen outlet pipe,
a nitrogen discharge pipe, and
an air inlet pipe,
the oxygen outlet pipe, the nitrogen discharge pipe, and the air inlet pipe respectively communicate with the first oxygen delivery pipeline, the nitrogen discharge pipeline, and the air inlet pipeline, and
any one of the oxygen outlet pipe, the nitrogen discharge pipe, and the air inlet pipe is fixedly disposed at the seat interface or the valve seat, and the remaining two pipes are attached in the holes in a limited manner and have gaps with the holes, respectively, and are detachably connected in the valve seat.

13. The modular oxygen concentrator according to claim 12, wherein
the oxygen outlet pipe is fixedly disposed at the seat interface,
the two through holes are a first hole and a second hole, and
the nitrogen discharge pipe is attached in the first hole, and the air inlet pipe is attached in the second hole.

14. The modular oxygen concentrator according to claim 13, wherein
the first hole and the second hole are both stepped holes, the nitrogen discharge pipe and the air inlet pipe each include a pipe body and a protrusion disposed on an outer periphery of the pipe body, the protrusion is in limiting fit with a large-diameter portion of the stepped hole, and the gap is present between the pipe body and a small-diameter portion of the stepped hole.

15. The modular oxygen concentrator according to claim 1, wherein
the molecular sieve module is detached from and attached to the main frame in a manner of sliding in a vertical direction.

16. The modular oxygen concentrator according to claim 15, wherein
a molecular sieve air receiving seat is disposed on a side of the main frame away from the compressor module, and has an air inlet channel and an oxygen outlet channel,
a bottom of the molecular sieve module is provided with a molecular sieve air inlet interface and a molecular sieve oxygen outlet interface,
after the molecular sieve module is installed in place in the vertical direction, the molecular sieve air inlet interface and the molecular sieve oxygen outlet interface are respectively inserted into the air inlet channel and the oxygen outlet channel in the molecular sieve air receiving seat to achieve hermetic connection, and
the other end of the air inlet channel communicates with the compressor air receiving seat by a pipeline, and the other end of the oxygen outlet channel communicates with the oxygen storage tank by a pipeline.

17. The modular oxygen concentrator according to claim 2, wherein
the first detachment structure includes
a filtering cavity opening provided at a bottom of the compressor module, communicating with a filtering cavity located in the compressor module and configured to filter inlet air of the compressor,
a cover body detachably disposed at the filtering cavity opening and configured to open or close the filtering cavity, and
a main frame opening provided on the main frame, having an opening size matching a size of the cover body, and configured to allow the cover body to be detached or attached.

18. The modular oxygen concentrator according to claim 17, wherein
the cover body has a cover body extension portion, and the cover body extension portion at least partially extends into the main frame opening to limit sliding movement between the compressor module and the main frame.

19. A modular oxygen concentrator comprising:
a main frame;
a compressor module and a molecular sieve module, at least one of the compressor module and the molecular sieve module being slidably and detachably connected to the main frame;
a locking/unlocking mechanism configured to lock or unlock a slidably detachable state of the compressor module and/or the molecular sieve module; and
a battery module located at a bottom of the main frame, and blocking the locking/unlocking mechanism when installed in place.

20. A modular oxygen concentrator comprising:
a main frame; and
a compressor module and a molecular sieve module, at least one of the compressor module and the molecular sieve module being slidably and detachably connected to the main frame, wherein
the main frame includes a compressor air receiving seat and a molecular sieve air receiving seat, the compressor module includes a vacuum pressure swing adsorption compressor, the vacuum pressure swing adsorption compressor includes a positive pressure air outlet and a negative pressure air inlet communicating with the compressor air receiving seat, and the molecular sieve module includes an air inlet and a nitrogen discharge port communicating with the molecular sieve air receiving seat,
the positive pressure air outlet communicates with the air inlet, and
the nitrogen discharge port communicates with the negative pressure air inlet.
